(19) United States
(12) Patent Application Publication
(10) Pub. No.: US 2023/0368252 A1
(43) Pub. Date: Nov. 16, 2023

(54) Merchant Donations Incenting Transactions Conducted On Gifted Sponsor Funded Virtual Prepaid Cards

(71) Applicant: Edatanetworks, Inc., Calgary (CA)

(72) Inventors: Terrance Patrick TIETZEN, Edmonton (CA); Matthew Arnold Macpherson BATES, Beaumont (CA)

(21) Appl. No.: 17/010,516

(22) Filed: Sep. 2, 2020

Related U.S. Application Data
(60) Provisional application No. 62/901,476, filed on Sep. 17, 2019.

(51) Int. Cl. G06Q 30/0279; G06Q 20/10; G06Q 20/32; G06Q 20/34; G06Q 20/40

(52) U.S. Cl. CPC G06Q 30/0279; G06Q 20/108; G06Q 20/3278; G06Q 20/351; G06Q 20/354; G06Q 20/401

(57) ABSTRACT

An issuer bank loads varying sponsor provided stored value amounts to inactive Virtual Payment Cards (VPCs), where the sponsor authorizes merchants and charities to receive merchant-defined donations incident to authorized transactions on the VPCs. The sponsor gifts each inactive VPC to a respective user of web access device by way of data corresponding to the inactive VPC. Each web access device transmits activation data to the issuer bank to active the inactive VPC. Each activated VPC is used to conduct an online transaction with a merchant. The merchant's acquirer bank sends an authorization for delivery to the issuer bank to validate the transaction amount and the merchant. If the issuer bank sends an authorization response to the acquirer bank indicating that the transaction is authorized, the merchant tenders goods and/or services for the transaction, and the merchant makes a merchant-defined donation to the one or more of the charities.

### RELATED APPLICATIONS

This application claims priority to U.S. Provisional Application Ser. No. 62/901,476, titled “Merchant Donations Incenting Transactions Conducted On Gifted Sponsor Funded Virtual Prepaid Cards,” filed on Sep. 17, 2019, which is incorporated herein by reference.

### FIELD

Embodiments described herein generally relate to incentives to consumers to use virtual payment devices to conduct transactions with merchants, and more particularly relate to a merchant making a merchant-defined donation as an incentive to a customer to conduct an online transaction with the merchant using a sponsor funded virtual payment device gifted to the customer.

### BACKGROUND

Merchants may use techniques to prompt consumers into making a particular purchase. These techniques may be in the form of monetary incentives, relying on the principle that a lower price will result in increased sales. Merchants may employ these techniques, for example, to help clear inventory before a new season's merchandise is released, to ease the release of a new product, to increase sales near the end of the fiscal year, to compete with a competitor over particular products, or to generally spur sales. Monetary incentives may come in the form of a “sale” (i.e., temporary reduction in price at the register), a discount coupon, a mail-in rebate (i.e., a refund of part or the entire purchase price by mail), or a store credit (i.e., credit that can be applied to another store purchase). These incentives may only apply to a particular product and have a time component. For example, a sale may only apply to a particular brand of dishwasher purchased on a particular holiday weekend and a rebate may only be valid for computers purchased within two weeks before the start of classes at a university. Although consumers are typically incented to make purchases by a form of price reduction, non-monetary reasons may also motivate consumers to make purchases with a merchant, for instance where the consumers believes that the merchant is a force for good and thus the consumers are non-monetarily incented to do business with the merchant who they deem worthy of such support. There exists a need for platforms, systems, methods, devices that may provide a non-monetary incentive to motivate a consumer to conduct a transaction with a merchant, or at least an alternative.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic illustrating an exemplary flowchart for a method of activating a virtual prepaid card via an application executing on a web enabled mobile computing device;

FIG. 2 is a flowchart illustrating an exemplary process that allows a user of a web enabled mobile computing device to use an activated virtual prepaid card to conduct an online transaction with a merchant that obligates the merchant to make a donation to an affinity entity after providing goods and/or services to the user;

FIGS. 3a and 3b illustrate screen shots characterizing exemplary user interfaces, respectively, for a user of a web enabled mobile computing device to activate a virtual prepaid card, and to optionally designate one or more affinity entities to whom contributions by the merchant are to be made incident to each transaction with the virtual payment card;

FIG. 4 is a flowchart illustrating an exemplary process for a sponsor to collaborate with an issuer bank to load a plurality of inactive Virtual Payment Cards (VPCs) within a predetermined BIN range with funds, send data corresponding to each inactive VPC to users of web enabled mobile computing devices, receiving input from the web enabled mobile computing devices at the issuer bank to active the VPCs, and authorization processing of subsequent transactions on the activated VPCs with merchants that are conducted by users of the web enabled mobile computing devices, with an optional post-transaction surveys being sent, and responses thereto being received back, via the web enabled mobile computing devices, and where each such transaction obligates each merchant to make an audited donation to an affinity entity;

FIG. 5 illustrates an exemplary system in which the processes of FIGS. 2, 4 and 6 may be performed by use of and access to an acquired account payment processing system, where the system provides functionality for processing transactions conducted by merchants with customers, wherein, for each transaction, there is a provision of a service or good by the merchant to the customer for the transaction, the customer pays for the service or good by conducting a transaction on an account for a virtual payment card issued to the customer, and there is an affinity entity to which a contribution is made by the merchant as a condition of the transaction;

FIG. 6 is a flowchart illustrating an exemplary process by which a transaction is conducted with a merchant by a customer using a virtual payment card, where the transaction obligates the merchant to make an audited donation to an affinity entity;

FIG. 7 illustrates an exemplary open loop payments processing system in which the processes of FIGS. 2, 4 and 6 can be performed, where the system processes transactions conducted by merchants with account holders using accounts associated with virtual payment cards, wherein, for each transaction, there is a provision of a service and/or good by the merchant to the account holder for the transaction, there is an authorizing and remunerating of an electronic payment by the account holder in conducting the transaction on the account with the merchant, and there are one or more charitable contributions by the merchant that are made to respective affinity entities incident to the transaction;

FIG. 8 illustrates exemplary systems housed within an interchange center to provide online and offline transaction processing for transactions conducted using the open loop payments processing system illustrated in FIG. 7; and

FIG. 9 illustrates further exemplary details of the systems illustrated in FIG. 8.

FIGS. 10 to 13 illustrates other exemplary systems in which the processes of FIGS. 2, 4 and 6 may be performed by use of and access to an acquired account payment processing system.

Implementations will become more apparent from the detailed description set forth below when taken in conjunction with the drawings.

### DETAILED DESCRIPTION

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, Ultra-Mobile PC (UMPC) tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer usable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may involve the execution of transaction and transfer of value between merchants and consumers to provide economic and commercial benefits. One should appreciate that the systems and methods described herein may involve particular configuration of computer hardware components to provide incentives to consumers and transfer value between consumers, merchants, card issuers, and affinity entities. One should appreciate that the systems and methods described herein may involve an interconnected network of computer hardware for transferring electronic data signals and executing transactions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Used herein are the terms digital card, virtual payment or cloud card, virtual credit card number, virtual card number (VCN), virtual gift card, virtual prepaid card, and Virtual Payment Card (VPC), which terms are intended to mean an online hosted, digital virtual representation of any plastic card or a generic identification method in Identity Management (IdM). A digital card, unlike a plastic card, doesn't require any physical representation as it is fully virtual and hosted online.

A VPC typically has an expiration date between two and twelve months from the issue date. The VPC number, which may be a Bank Identification Number (BIN), is generated through the use of either a Web application or a specialized client program, interacting with an issuer bank's computer. While it could usually be set up to allow multiple transactions, it could only be used with a single merchant or a limited set of merchants. An inactive VPC can be activated by use of a Globally Unique Identifier (GUID), such as a Prepaid Digital Token (PDT) is a 14-digit alpha-numeric code. A PDT is given to a person as a reward or payment for an incentive, promotion, or other type of approved program, and will usually be embedded in an email link, transmitted wireless to a web enabled mobile computing device, tendered on a piece of paper, etc. When received via a hyperlink, when a user clicks the hyperlink or the user enters a valid PDR into a device having Web access, an inactive VPC can be activated. Typically, PDTs are distributed by Program Sponsors to users as a reward or incentive. PDTs can have an expiration date per the Program Sponsor's rules, and PDTs can't be used after expiration.

A type of a virtual payment card (VPC) is a virtual gift or prepaid card number (VPN) that is typically used for online purchases. VPNs are not associated with a physical card, and consequently cannot be used for in-person transactions. Unlike the numbers generated by online credit card number generators, funds must be deposited into an account associated with the VCN prior to usage.

VCNs can be acquired from online VCN providers, banks, and some partners of transaction handlers (e.g., Visa, MasterCard). Online VCN providers often assess service charges to pay banks, credit card companies, and/or credit networks for the costs of obtaining and servicing VCNs.

A VPC provides flexibility to the user. The VPCs can be created for any online bank accounts and there often is no limit to the amount that can be loaded into these cards, and can use any supported currency to charge up the VPC. Activating a VPC involves filling up a form with transaction details (account information, card number), phone number for verification and optionally other data. Once the form is submitted, the user will receive a confirmation from the issuer bank verifying the link. The VPC is then forwarded to the user by the issuer bank, or its agent, in the form of a card number, and the user can thereafter use the VPC on any online platform as would a normal debit/credit card would be used.

A VPC typically includes a Bank Identification Number (BIN_ three parts consisting of sixteen digits, a card security code (CSC) (also termed card verification code (CVC) and card verification value (CVV/CVV2)) is also associated with the VPC to establish card ownership by the buyer and to authorize transactions, and date of expiration. The VPC may be transmitted via a cellular telephone, Wi-Fi, Bluetooth or other transmitter. The virtual card may be embodied and transmitted in an SMS, Twitter, email, or other electronic message or form. The VPC can exist both virtually and physically. Merchants can run a VPC as a credit or a debit transaction, and some stores may let the customer choose.

If a VPC holder wants to make a purchase that totals more than the stored value amount on the VPC card, the merchant can authorize a split the transaction to use the current balance on the VPC, and then use a different form of payment (cash, check, a personal card, etc.) for the difference. A VPC holder check the VPC's balance, card details, mail dates, PINs, spend history, etc. online by logging into the VPC account at a predetermined website you. If a purchase totals more than the amount on the VPC and the merchant processes the VPC correctly by sending the issuer bank an authorization request, the transaction will be declined. In some implementations, a VPC can be added to other digital wallet system such as Apple Pay®, Samsung Pay® or Google Pay™. When a VPC holder adds a VPC to a digital wallet, a one-time validation passcode may be sent to the user via SMS text or by use of other methodologies if the user has not yet associated a mobile telephone number in the VPC's profile. Depending upon a sponsor's rule, a VPC can be used with funds transfer apps or services, such as Venmo, PayPal and Zelle. However, rules of a VPC sponsor may make the VPC incompatible with apps or services that allow the user to send funds digitally to numerous merchants or other people. Typically, a VPC sponsor will specify a ‘White List’ that contains a predetermined set of Merchant Identifiers (M-ID). Each merchant having an M-ID on the White List will be permitted to conduct transactions with the VPC and other merchants will not be permitted to conduct transactions with the VPC. Typically, the M-ID is included in the merchant's acquirer bank authorization request that is sent to the issuer bank for the VPC. The issuer bank used the M-ID in the authorization request to determine whether or not the M-ID is on the White List. If M-ID is not on the White List, a message to the effect that the transaction is declined will be sent in an authorization response from the issuer bank to the acquirer bank and then to the merchant.

In some implementations, a sponsor pays an issuer bank to load value onto virtual prepaid cards (VPC) in different amounts. The VPCs may have a predetermined BIN range. The sponsor also gives the issuer bank a White List of authorized merchants who can accept the VPC for a transaction with a consumer. Each merchant on the White List has a Merchant ID (M-ID). Merchants on the M-ID white list are eligible to accept a VPC in an online transaction with the VPC holder. The condition required for each merchant's M-ID to be on this M-ID White List is that each such merchant has agreed to make a merchant-defined donation, which may be a percentage of the amount of each online transaction on the VPC, to a charity selected by the VPC holder or the sponsor. In still other implementations, a sponsor pays an issuer bank to authorize a plurality of virtual prepaid cards (VPC) in different amounts each of which, however, would not be loaded until the time that they are respectively activated. As such, for example, if one hundred thousand (1000,000) VPCs in different amounts were given out to VPC holders but only twenty-five thousand (25,000) VPCs were activated by the VPC holders, then the issuer bank would only fund the twenty-five thousand (25,000) activated PCs, whereas the remaining seventy-five thousand (75,000) VPCs would be able to be used elsewhere.

By way of example, and not by way of limitation, a sponsor may designate one and only one charity to whom merchants are to make a merchant-defined donation. The sponsor, or its agent, may distribute tokens for inactive VPCs to attendees of a large sports stadium, such as at a professional hockey game. During the game, information is communicated to the attendees of the professional hockey game, such as via a jumbotron or large marque display over the hockey rink. This type of messaging might include information needed in order to activate the inactive VPC and an announcement of the sponsor's designated charity (e.g., “Today's charity is the Edmonton Dog Rescue Home.)”

Alternatively, when the VPC holder activates the VPC, the VPC holder may make a predetermined designation of one or more charities to whom the merchant-defined donation is to be made by the merchant.

In some implementations, where the merchant-defined donation is to be made by the merchant, the donation is an incentive to the VPC holder to conduct a transaction with the merchant, where the amount and type of the donation is derived by a neural network of an artificial intelligence engine that uses (i) the corresponding a profile of the VPC holder; and (ii) the corresponding profile of the merchant.

In yet other implementations, when a transaction is conducted by a VPC holder with a merchant, transaction data for the transaction is communicated by data signals exchanged via at least one of: (i) near field communication (NFC) devices for the transaction between the VPC holder and the merchant; and (ii) a short range wireless network operating protocol that is at least one of the 802.11 family of standards and the frequency range of 2.4 to 2.48 GHz.

The VPCs can have any of the following distribution methodologies by which the loaded inactive VPCs are distributed to VPC holders in such as fashion that the amount on each VPC is randomized so that each person is given a VPC with a preloaded amount that is likely to be different than the person getting a VPC before and after that person (i): anyone with a web enabled mobile computing device (e.g., smartphone) that enters a geofenced area (e.g., at the entrance to a large venue sports event such as a hockey stadium) gets a message delivered to a logical address associated with their smart phone with a payload of the data that includes a digital token, virtual E-Certificate, Globally Unique Identifier (GUID), QR code, or BIN which is later used in order to log in to a web site at which an inactive VPC can be activated; (ii) a person shows a QR code, or other symbology, displayed on the smartphone display screen that serves as an entrance ticket to be admitted to attend an event at a stadium or other performance event venue. The machine that reads the QR code on the smartphone display also messages the smartphone with a payload of the data that includes a digital token, virtual E-Certificate, Globally Unique Identifier (GUID), QR code, or BIN that is needed in order to log in to a web site at which an inactive VPC can be activated; and/or (iii) a paper with a digital token, virtual E-Certificate, Globally Unique Identifier (GUID), QR code, or BIN is handled out to each ticket holder at a stadium or other performance event venue, which GUID, QR code, or BI is used by the ticket holder with a smartphone, or other web access device, in order to log in to a web site at which an inactive VPC can be activated to login to cash-in.

Initially, the VPC holder uses a URL and/or installed ‘app’ to enter the digital token, virtual E-Certificate, Globally Unique Identifier (GUID), QR code, or BIN in order to access a website and see a webpage showing the money preloaded by a sponsor as a stored value on an inactive VPC. The VPC holder then may input a username and password to active the VPC so that the VPC can thereafter be used to conduct an online transaction with merchants on the M-ID white list, to see the VPC's remaining balance after online transactions have been conducted, and to see the online transactions that have already been conducted with M-ID white listed merchants.

In other implementations, the VPC holder uses a URL and/or installed ‘app’ to enter the digital token, virtual E-Certificate, Globally Unique Identifier (GUID), QR code, or BIN in order to access a website and see a webpage showing the money preloaded by a sponsor as a stored value on an inactive VPC. In such other implementations, however, a new account is created and issued by an issuer for the VPC holder in the event that the VPC has not yet already been issued an account. As such, the VPC holder use of the URL and/or the installed ‘app’ drives adoption and engagement by the VOC holder.

A brand, trademark, or trade dress may be used or displayed by each merchant on the M-ID White List, such as in electronic communications, websites, advertisements, etc., as a way for VPC holders to know which merchants are authorized by the sponsor to conduct transactions with the VPC.

When a VPC user activates an inactive VPC, further incentives may be given to the VPC holder, such as an entry for a sweepstakes contest or a discount on a merchant's goods or services. After the VPC holder has transacted with a merchant on the White List, the VPC holder may be sent a post-transaction survey, and the VPC holder may be incentivized to respond to the survey by being gifted with an entry for a sweepstakes contest or for a discount on a merchant's goods or services. As such, the VPC holder has a plurality of incentives to participate in conducting transactions and responding to post-transaction surveys.

When the VPC holder uses the activated VPC to conduct an online transaction with a merchant, the acquirer bank sends an authorization request for the online transaction through a transaction handler (e.g., Visa, Mastercard) to the issuer bank of the VPC. The issuer bank ensures that the transaction amount is not greater than the currency value on the VPC, and also checks to ensure that the merchant has an M-ID that is on the M-ID white list provided by the Sponsor to the issuer bank. If either condition is not met, the issuer bank sends an authorization response to the acquirer bank that is negative in that the transaction is declined by the issuer bank. Otherwise, the issuer bank sends an authorization response to the acquirer bank that is positive in that the transaction is authorized by the issuer bank. Note that the acquirer bank sends the authorization request but does not check to see if the M-ID is on the M-ID white list provided by the sponsor.

For each of the transactions on the VPC that is authorized by the issuer bank, the merchant is obligated to make a merchant-defined donation (e.g. typically a percentage of the transaction amount) to a charity selected by the VPC holder or selected by the sponsor. Optionally, local escheatment law for any remaining currency balance on the VPC after its expiration date (a.k.a. slippage, breakage) may be optionally overridden by the choice of the sponsor in that these funds are sent by the issuer bank to the charity that is designated by the sponsor and/or the VPC holder.

In still other implementations, a user of a web access device, such as a web enabled mobile device, smartphone, Amazon Echo, Google Home, Google Home Hub, Lenovo Smart Display, Harman-Kardon Allure, Apple HomePod, Triby Smart Speaker, Mycroft Mark, JBL Link View Smart Speaker, Sonos One, Harman Kardon Invoke, or other Internet-of-Things enabled smart device may have the ability to active an account corresponding to an inactive VPC. For example, the user may have a loyalty account associated with a business or credit rewards account associated with a credit card company, and the VPC may be controlled by the corresponding business or credit card company. The holder the VPC may request a virtual rewards card associated with the loyalty account from the VPC. For example, the user may operate a web access device to execute an application associated with the loyalty account and request the virtual rewards card from the sponsor through the application. In some cases, the web access device may install the application in order to request or generate an inactivated VPC. Once created, the virtual rewards card may be placed within a virtual wallet (e.g., Apple Pay, MasterPass, Android Pay, Samsung Pay, Chase Pay, Wells Fargo Wallet, etc.) implemented on the web access device. A balance of the VPC may be displayed within the virtual wallet. In some cases, the balance may be updated in near real-time based on notification from a redemption server.

A merchant may be involved in an online transaction with a VPC by processing the BIN for the VPC on the merchant's point of service (POS) device. The POS device initiates processing of purchases of the VPC. For example, when a user of the web access device attempts to use the VPC at a merchant's website, the merchant's POS device receives information about the VPC from the VPC holder's virtual wallet, and the POS device authorizes the purchase with an issuer bank optionally via a redemption server, for example, through a payment network. The redemption server confirms an available value for the VPC (e.g., by confirming currency balance on the VPC controlled by the issuer bank), and authorizes the purchase.

In some cases, the merchant at a brick and mortar store may have a POS device, or like physical device at the merchant location, that is capable of inputting data from the VPC in order to facilitate an online transaction with the merchant. In some circumstances, the POS device may be contacted through an application executing on the VPC holder's web access device or through a web portal (e.g., accessed on the web access device). In some circumstances, the merchant's POS device may include a third-party payment processor device utilized by a merchant to process purchases. In some cases, various digital payment methods (e.g., Apple Pay, Visa Checkout, MasterPass, etc.) may convey information associated with the VPC to the web access device.

In some cases, a sponsor, or its agent, may have a server that sends an e-mail to a VPC holder at an e-mail address associated with the loyalty account. The VPC holder may access the e-mail on their web access device. The e-mail may link to the loyalty account (e.g., the application associated with the loyalty account or a website associated with the loyalty account). The VPC holder may log into the loyalty account (e.g., through the application or through a website), and indicate that they would like a reward to be added to their virtual wallet via an new or existing VPC. The web access device (e.g., via an installed application) may be operated by the VPC holder to contact the sponsor, which passes the registration information to a redemption server operated by an issuer bank.

According to certain implementations, the functionality for the VPC holder to add the VPC to their digital wallet may be provided in various ways. For example, in some embodiments, a mobile application (e.g., an installed application) of a Loyalty Program may include VPC addition functionality. For example, the mobile application may incorporate a Software Development Kit (SDK) provided in association with the issuer bank's redemption server. In some implementations, a mobile application (e.g., an installed application) may be associated with the issuer bank's redemption server and may provide VPC-addition functionality to the VPC holder's web access device. In some cases, a website corresponding to the Loyalty Program may include the VPC-addition functionality, for example, by implementing routines provided in association with the issuer bank's redemption server.

At the issuer bank's redemption server, a virtual rewards account (VRA) can be created for the VPC holder in order to accumulate loyalty rewards for the VPC holder. The VRA may include, for example, an account number, an expiration, a verification value (e.g., a Card Verification Value), a billing address, a shipping address, and user information. In some cases, the shipping and billing addresses may be associated with the VPC holder. In other circumstances, the billing and shipping addresses may be associated with the issuer bank's redemption server. In some implementations, the issuer bank's redemption server may receive and create the VRA based on one or more of the VPC holder's information, loyalty account information, and web access device information (e.g., a logical address of the VPC holder's web access device).

A VPC holder may use a web access device to initiate a purchase using the one or more of the VPCs when the VPC holder attempts to purchase merchandise in an online transaction with a POS of a merchant using a VPC. The VPC holder's web access device may provide information on the VPC to the merchant's POS.

When the purchase is authorized, as a non-limiting example, the merchant's POS may receive the VPC information from the VPC holder's web access device, and request authorization from the issuer bank's redemption server. The redemption server determines whether sufficient funds are available in the VPC (e.g., whether the BIN associated with the VPC has stored value for the transaction amount). By utilizing the redemption server within the purchase authorization, in some cases, purchases may be approved in real-time based on changing conditions. As non-limiting examples, transactions may be limited by capped transaction values, transactions may be limited to particular merchants on the M-ID White List, retail offers, coupons, discounts may be applied in real-time to incent the VPC holder to conduct a transaction, and the transaction amount may be adjusted based on location of the VPC holder or its web access device (e.g., based on a current store visited by the VPC holder). In some cases, a merchant ID may be provided with a transaction authorization request, and a conversion rate may be specific to a particular merchant or type of merchant.

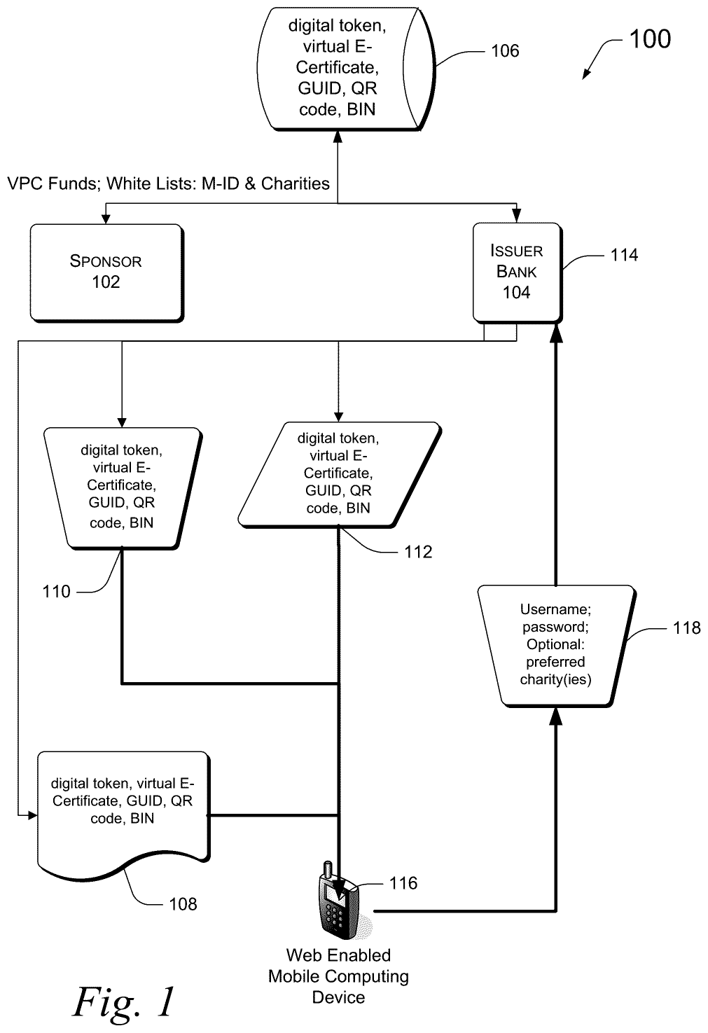

Referring now to FIG. 1, a process 100 includes steps by a Sponsor 102 to provide funds to an Issuer Bank 104. Issuer Bank 104 loads the Sponsor's funds, in a variety of different values, on to inactive Virtual Prepaid Cards (VPCs) each of which has a Bank Identification Number (BIN). A code is also associated with each BIN, where the code is used to activate the corresponding inactive VPC. Each code can be a digital token, a virtual E-Certificate, a Globally Unique Identifier (GUID), a QR code or other symbology, a BIN, etc. At steps 110, 112, and/or 108, Issuer Bank 104 sends the codes so as to be accessible by VPC holders who have access to a web access device 116.

The methodology by which a code is communicated for use by each operator of web access device 118 can include, but is not limited to, an act of printing the code on at least one of an issued ticket, a receipt, a scratch ticket, a lottery ticket, a receipt for purchase, a receipt for an award, a ticket to an event, another receipt, a direct market mailing, an electronic communication, a cellular network communication, a wireless device communication, and/or a classified newspaper advertisement, and/or conveying the code verbally via at least one of a telephone network, an advertisement, and/or a public address system. Activation of an inactive VPC using the code with web access device 118 may provide a further incentive to the VPC holder such as an entry into a sweepstakes, wherein a wining result of the sweepstakes includes at least one of an award, an incentive, and a benefit for the VPC holder.

Web access device 116 is used, with the received code and other input information, to activate a corresponding inactive VPC at step 118 via communications with Issuer Bank 114, Sponsor 102, and/or their agents. The VPC holder may use web access device 116 to input a selected username and password in order to have future access to data pertaining to the activated VPC, including stored value balance, past transactions, etc.

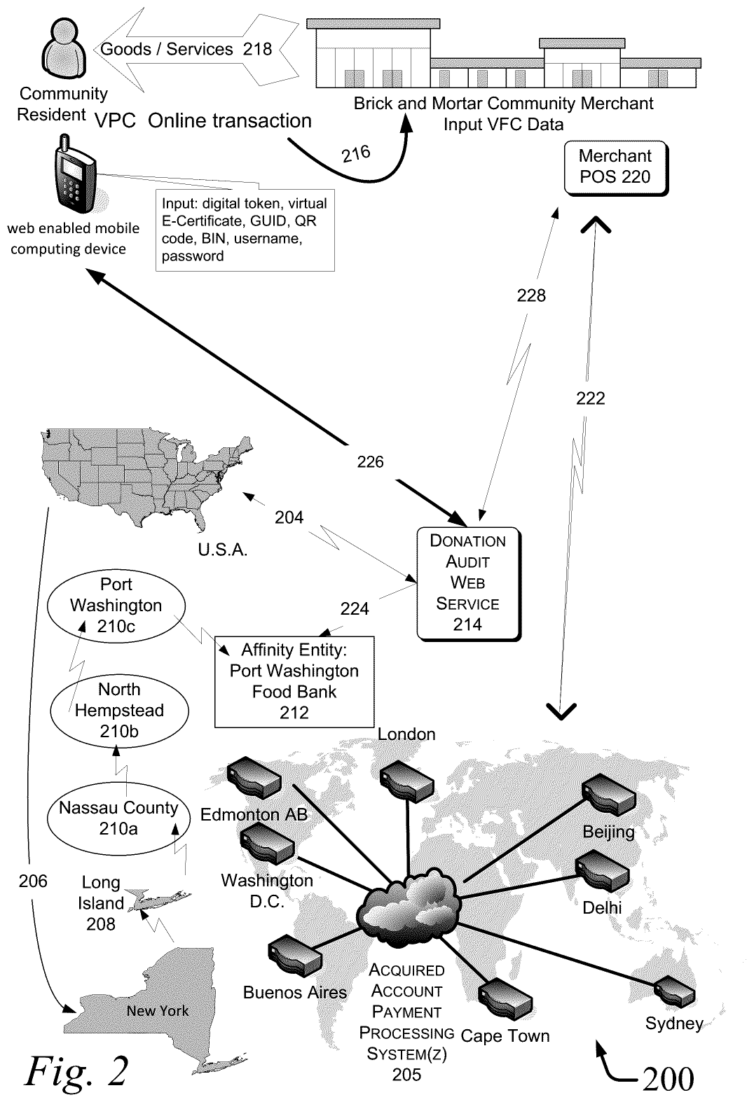

Referring now to FIG. 2, an environment 200 is depicted for a global acquired account payment processing system 205, as shown. Environment 200 includes a VPC holder performing a step 216 to operate a web access device that executes an application allowing the VPC holder to use a VPC to conduct an online transaction with a merchant. Alternatively, data corresponding to the VPC can be physically presented at the location of a merchant having a brick and mortar store, and the merchant can use a Merchant POS 220 to input the VPC data to conduct the online transaction. Each such transaction includes terms and conditions that obligate the merchant to make a donation to a local affinity entity if the VPC holder conducts a financial transaction, according to predetermined terms and conditions, with the merchant. As such, the VPC holder is incentivized to buy from the merchant by the merchant's agreement to make a donation to an affinity entity.

By way of example, the affinity entity may be an organization that provides a good and/or service to which both customers and merchants have an affinity—such as by their common geographic location. This affinity entity may provide food and clothing to needy families in their common community. This affinity entity may provide teaching and demonstrations of entrepreneurial skills to community's unemployed. Another affinity entity may provide venues where sports education can be provided to local competing teenagers. Yet another affinity entity may provide care and feeding to abandoned pets. The affinity entity may also cultivate good citizenship and public policy. An affinity entity may be either a for-profit or non-profit organization providing a good or a service to a local community to which both merchants and customers in the same community have an affinity, by their common location, to advance and/or promote.

Referring again to FIG. 2, Donation Audit Web Service 214 may use respective identifiers for the merchant and its customer to access and retrieve geographic information for each, then applies an algorithm to the retrieved geographic information to determine the respective local communities of the merchant and its customer. Alternatively or additionally, Donation Audit Web Service 214 may obtain a current location for a user via location detection module on the user's smart phone (e.g. GPS, Wi-Fi, satellite, etc.). As shown in FIG. 2, the local community may be progressively granular in nature, such as first the United States of America as shown at reference numeral 204, then the state of New York as shown at reference numeral 206, then the portion of New York called “Long Island” as shown at reference numeral 208, then the county of Nassau shown at reference numeral 210a, then a portion of the Nassau County called North Hempstead as shown at reference numeral 210b, and then the specific geographic location of “Port Washington” as shown at reference numeral 210c. This final level of geographic granularity indicates a community in which both merchant and customer are members, neighbors, residents, and/or the like.

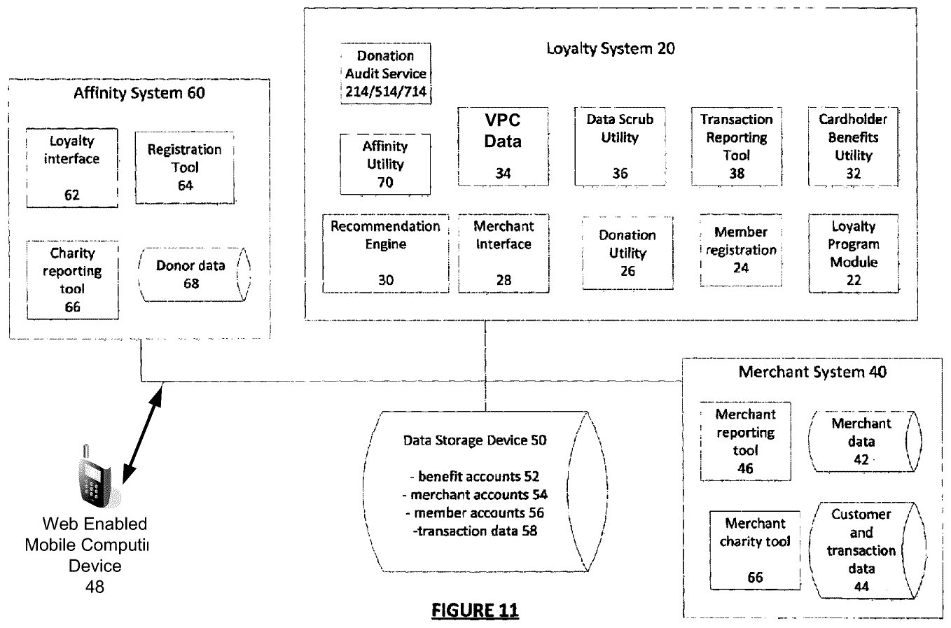

The final level of geographic granularity may be used to perform a look-up against one or more databases to which Donation Audit Web Service 214 has access. This access and lookup may be used by Donation Audit Web Service 214 to identify: (i) the affinity entity or charity for that community which, as shown at reference numeral 212, is the Port Washington Food Bank, has been specified by the customer; and (ii) the respective identifier of the merchant's business rule (and/or the customer's business rule) that is to be used to make a calculation of the donation that the merchant to make to the affinity entity or charity for that community. The business rule(s) that may be used with the currency amount of the customers payment to calculate the donation that is to be made by the merchant to the affinity entity or charity for that community. Note that the donation may be directed to a plurality of affinity entities for the local community according to directions that had been previously specified by the customer (and distributed via affinity system 60 of FIG. 11). For example, the customer may have specified that each merchant donation is to be split evenly, or in specified portions, between five (5) local community affinity entities, for example: (i) a local youth sports team cooperative; (ii) a local charter junior high school; (iii) a local house of worship; (iv) a local political party; and (v) a local for-profit college specializing business entrepreneurialism.

At step 216, the VPC holder conducts an online transaction via the Merchant POS 220 on the VPC BIN corresponding to an account issued by an issuer to the VPC holder to pay for the transaction and buy goods and/services 218 received by the VPC holder.

The merchant's offer to donate may not be specific to a particular good or service, but rather may be specific to the entire transaction between the merchant and its customer. By way of example as to this type of offer specificity, the transaction on the VPC may obligate the merchant to make a donation of a certain percentage of the entire currency amount of transaction, or may obligate the merchant to make a donation only if the transaction is conducted at a certain time of day or on a particular day of the week, or a combination of the foregoing. Although some terms of the donation may differ from some terms of the subsequent transaction between the merchant and its customer, nevertheless, the merchant will make a donation to an affinity entity (e.g., a charity) fundamentally provided an incentive that caused, at least in part, the VPC holder to conduct the online transaction with the merchant, or to navigate to the merchant's brick and mortar store, come into the store, and ultimately ask the merchant to conduct the online transaction by use of Merchant POS 220 with the VPC holder's VPC.

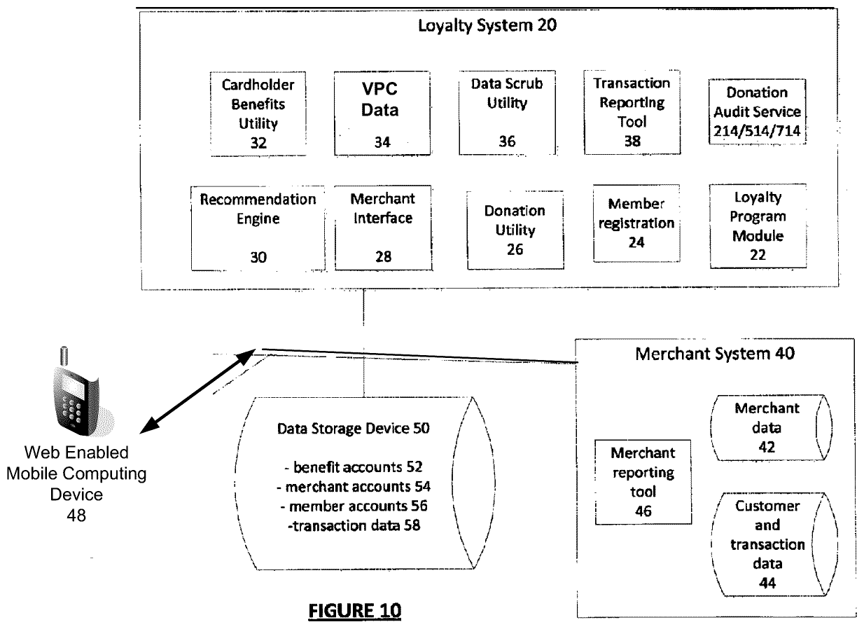

In the event that the VPC holder cannot use a web access device to conduct an online transaction with the merchant, as an alternative, the merchant at its brick and mortar store can input VPC data for a transaction into a Point of Service terminal (POS) seen at reference numeral 220 in order to facilitate an online transaction using the VPC. The POS, for example, can be a cash register or a web enable mobile device (e.g., a tablet computing device). The POS may be integrally part of a merchant computing system 40 (FIG. 10) or connected thereto. The POS 220 transmits the input data to an Acquired Account Payment Processing System. The Acquired Account Payment Processing System sends a signal, as shown at reference numeral 222, to Donation Audit Web Service 214 indicating that a transaction on the community resident's account was approved for being conducted by the community resident with the merchant whose offer was selected by the community resident. Optionally, the data input into POS 210 can include additional monies received from the customer by the merchant that are also to be donated, via the merchant, to the affinity entity or charity for that community. Upon receipt of the signal, a donation to the community affinity entity by the user's selected merchant may be calculated according terms and conditions specified by the merchant.

The Donation Audit Web Service 214 may retain the derived donation for subsequent audit purposes to ensure compliance by each community merchant in its donation commitments to each of the one or more affinity entities or charities for each community that the merchant and/or its customers is a member. The Donation Audit Web Service 214 also may transmit a message containing notice of a donation, or the particularly derived donation, for the customer's transaction, as shown at reference numerals 224, 226, and 228, respectively to logical addresses of the affinity entity or charity for that community, the community resident and the merchant.

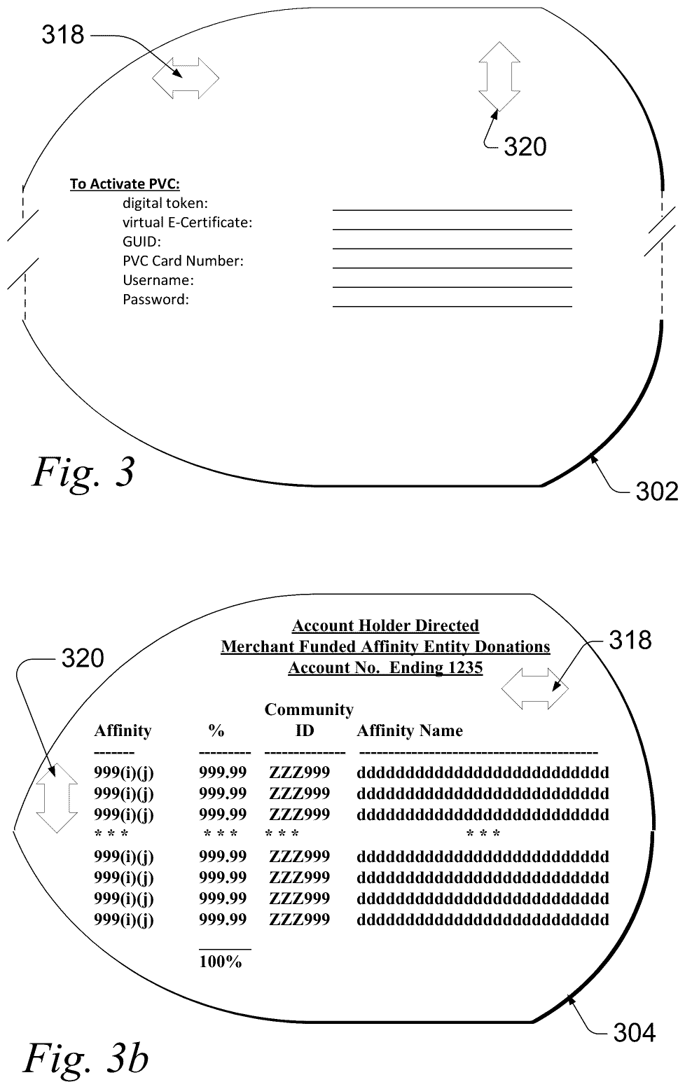

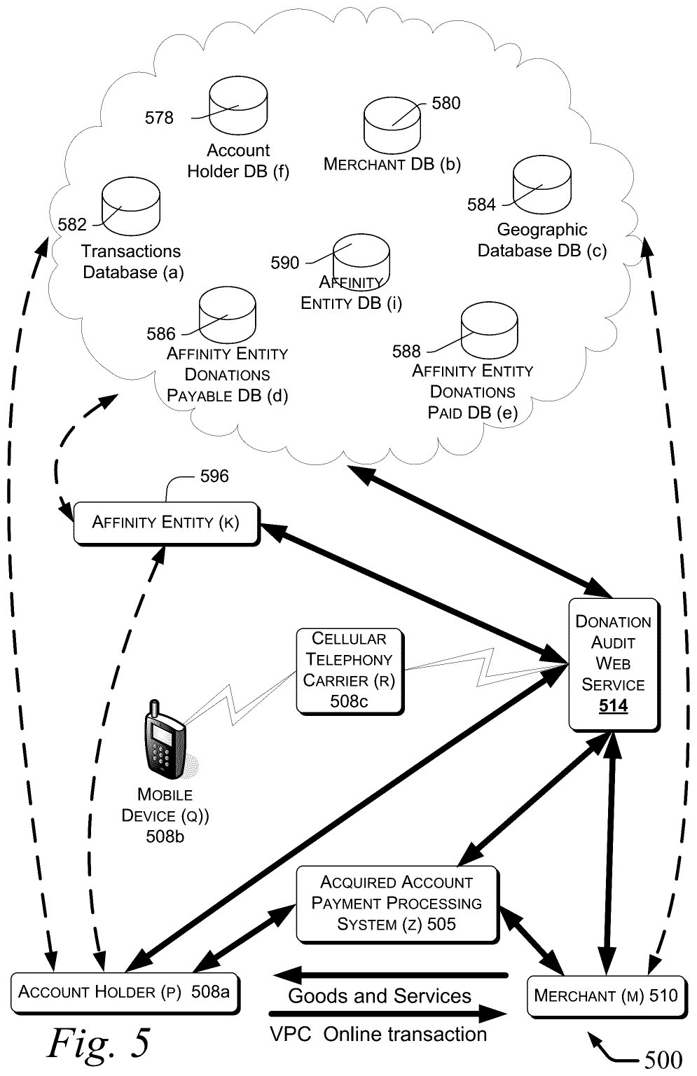

Referring now to FIGS. 3a-3b and 5, a screen shot 302 features input and displays fields by which a VPC holder can input data to activate an inactive VPC. These data can include a digital token, a virtual E-Certificate, a GUID, a BIN, and/or a VPC Card Number. The VPC holder can also input a selected username and password in order to have future access to data pertaining to the activated VPC, including stored value balance, past transactions, etc.

Referring now to FIG. 3b, a screen shot 304 features input and displays fields by which an Account Holder (p) 508, or agent thereof, can direct a third party donor, such as a Merchant (m) 510 with whom the Account Holder (p) 508 is conducting a transaction, to be obligated to make a donation to an Affinity Entity (k) 596. The fields provided by screen shot 304 allow the customer to specify one or more affinity entities in their local community to which donations are to be made by merchants with whom the customer conducts transactions. In such implementations, each merchant is given notice of its total periodic donations. Such notice, however, can optionally be given without providing the merchant with any notice or knowledge as to the specific identity of those affinity entities that are to be the recipients of its donations. The donation mechanism can be set up such that the merchant makes blind donations, either directly or indirectly, to affinity entities in the local community of both the merchant and its customer who selects those local community affinity entities. Accordingly, the donation mechanism may leave direction of merchant's donations fully within the discretion of the merchant's customers, limited only by the restriction that the customer can only select from among those affinity entities that serve the local community that is in common to both the merchant and the customer, while leaving the actual amount of the merchant's donation fully within the discretion of the merchant.

Optionally, a further limitation on those local community affinity entities that may be selected by the customer may include control logic that accesses a rating, and/or that derives a rating, for an affinity entity. The control logic may use one or more ratings given by one or more charity rating organizations, where the control logic result is used to determine whether or not the affinity entity is eligible for participation in the implementation as a registered affinity entity that is selectable by local community customers. This may be used by recommendation module 30 (FIG. 10) to generate and identify incentive to VPC holders and affinity entities associated with the various merchants and incentives. The ratings may be retrieved by Donation Web Service 214 by its access to one or more databases (e.g. data storage device 50 of FIG. 10) where such ratings are input and maintained. Example of charity rating organizations which provide one or more ratings that could be used for various disclosed implementations include Guide Star, Charity Navigator, Give Well, Evangelical Council for Financial Accountability (ECFA), the Better Business Bureau Wise Giving Alliance Standards for Charity Accountability of the Council of Better Business Bureaus, Inc., and the like that now exist or may exist in the further. Moreover, other mechanisms for assessing local community affinity entities may be used to determine whether or not affinity entities are eligible for participation in the disclosed implementations as registered affinity entities that are selectable by local community customers and/or local merchants.

Each row in screen shot 304 of FIG. 3b may represent a different Affinity Entity (k) 596 in the local community of the customer for which there is a specific code (e.g., 999(i)(j), Community Identifier (e.g., ZZZ999), and Affinity Name as shown in FIG. 3b. A pull down menu of selectable affinity entities (not shown) can be used to provide selectable input to the fields corresponding to affinity entities shown on screen shot 304.

By way of example, the Affinity Entity and/or the Community ID might identify a specific Affinity Entity (k) 596 that is located in, and provide goods and services to, the borough of Greenwich Village at the southern portion of the geographical island of Manhattan in the city of New York of the State of New York, in the USA. By way of example, and not by way of limitation, the Affinity Entity Code 105(064) (q2e) could have an interpretation where ‘105’ represents the United States of America, the index ‘064’ represents the state of New York, “q” represents the City of New York, “2” represents the combined boroughs of Manhattan, and “e” represents the borough of Greenwich Village at the southern portion of the geographical island of Manhattan in the city of New York of the State of New York. The name of the specific Affinity Entity (k) 596 represented the code 105(064) (q2e) can be the Washington Square Food Bank, which may be located in, and provide goods and services to, the borough of Greenwich Village at the southern portion of the geographical island of Manhattan in the city of New York of the State of New York, in the USA. Note that the Account Holder (p) 508 can use screen shot 304 to specify multiple community IDs each representing a geographic location where the Account Holder (p) 508 either has a residence or operates a business in the geographic location. Also note that, for each such community ID specified by the Account Holder (p) 508, the second column of the rows of screen shot 304 in FIG. 3b may add up to 100%, thereby provide a percentage the donation made by the Merchant (m) 510 with whom the Account Holder (p) 508 conducting a transaction.

For screen shot 304, input and selection of data for each Affinity Entity may be via a typical user experience including but not limited to keyboard data entry, pull down menus, pictograph optical scanning with a cellular telephony device as read from print or electronic media rendering, etc. Horizontal 318 and vertical 320 panning, as seen in FIGS. 3a-3b, can be user activated to move that portion of the display being rendered horizontally and vertically, respectively. The data may be stored in data storage device 50 (FIG. 10)

The VPC holder, e.g., Account Holder (p) 508, may change or disable a donation commitment at any time by accessing a server that serves web pages rendering screen shot 304. Thus, charitable donations can be easily and instantly, be both enabled and/or disabled, using the real time user interface. By way of example, and not by way of limitation, one or more of such servers may be hosted by the Donation Audit Web Service 514 seen in FIG. 5.

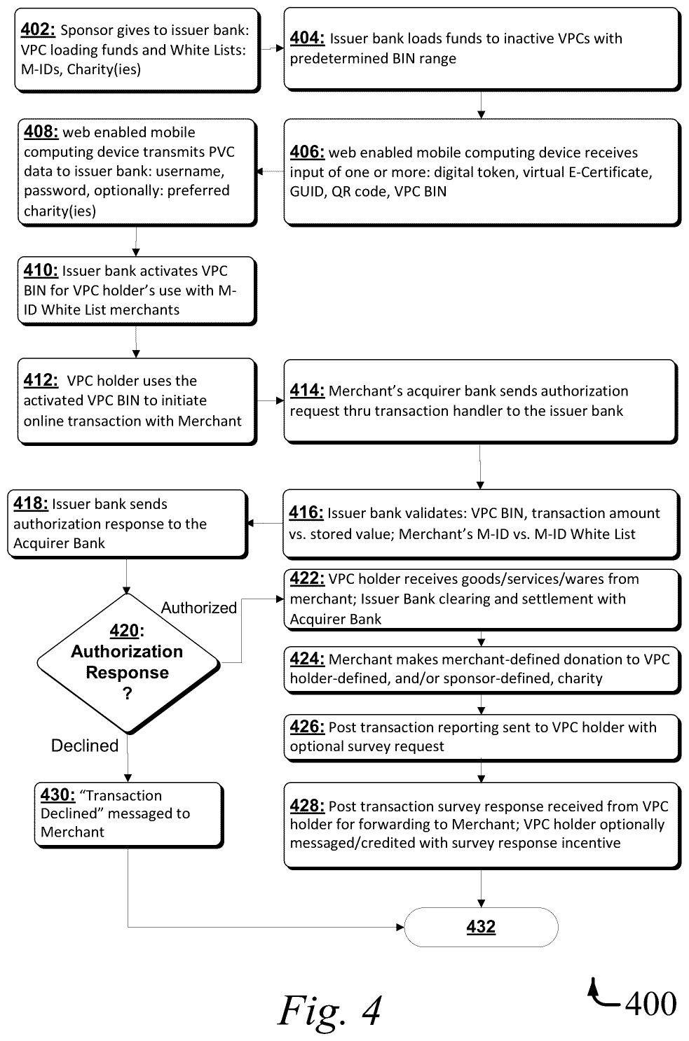

Referring now to FIGS. 4-5, a Method 400 is illustrated by the flowchart shown in FIG. 4. Reference may also be made to FIGS. 10 to 13 and system components thereof which may be used to implement Method 400 by which a VPC holder conducting a transaction with a merchant obligates the selected merchant, by terms specified by the merchant, to make an audited donation to an affinity entity.

At step 402 of Method 400, a sponsor tenders to an issuer bank: (i) funds to load onto a plurality of inactive VPCs; and (ii) White Lists each including a predetermined set of merchants respectively identified by Merchant ID (M-ID), and optionally including a predetermined set of affinity entities (e.g., Charity(ies)).

At step 404 of Method 400, the Issuer bank loads the VPCs each of which are within a predetermined BIN range.

At step 406 of Method 400, a web enabled mobile computing device receives input of one or more data items: digital token, virtual E-Certificate, GUID, QR code, VPC BIN, username, password, and optionally identifiers respectively corresponding to the VPC holder's preferred charity(ies).

At step 408 of Method 400, a web access device, such as a web enabled mobile computing device, transmits input data for the VPC to the issuer bank.

At step 410 of Method 400, the Issuer bank activates each inactive VPC as to its BIN for the VPC holder's use with the M-IDs with the merchant's White List.

At step 412 of Method 400, the VPC holder uses the activated VPC to initiate an online transaction with a merchant.

At step 414 of Method 400, the Merchant's acquirer bank sends an authorization request for the online transaction through a transaction handler to the issuer bank.

At step 416 of Method 400, the Issuer bank validates: (i) the transaction amount vs. the VPC's stored value; and (ii) the Merchant's M-ID vs. M-ID White List.

At step 418 of Method 400, the Issuer bank sends an authorization response to the acquirer bank.

At step 420 of Method 400, a query is made as to the authorization response. Method 400 moves to step 430 if the authorization response contains data indicating that the transaction was declined by the Issuer bank, such as by the transaction amount exceeding the VPC's stored value, or the Merchant's M-ID not being on the M-ID White List. If the transaction is not authorized, Method 400 terminates at step 432. Otherwise, Method 400 moves to step 422 at which the VPC holder receives goods/services/wares from merchant.

At step 424 of Method 400, the merchant makes a merchant-defined donation to VPC holder-defined, and/or sponsor-defined, one or more affinity entity(ies) (e.g., charity(ies))

At step 426 of Method 400, a message is sent to a logical address corresponding to the VPC holder pertaining to the transaction, which may also contain a request for the VPC holder to complete a post-transaction survey.

At step 428 of Method 400, the VPC holder's post-transaction survey response is sent to the merchant and the VPC holder' is optionally messaged and/or credited with a survey response incentive. The survey response incentive can be an entry for a sweepstakes contest or a further discount on a merchant's goods or services. As such, the VPC holder has a plurality of incentives to participate in conducting transactions and responding to post-transaction surveys.

In other implementations, a sponsor can tender to an issuer bank funds to load onto a plurality of physical gift cards to be gifted as gifts to consumers. For example, a physical gift card can be provided to a potential loyalty system member with a piece of paper, or equivalent means of communication, that includes directions on how to activate the physical gift card and discover it's stored value (e.g., by logging in to a website). Thereafter, that physical gift card can be used for in-person transactions at physical merchant stores. In such other implementation, other steps illustrated for Method 400 as shown in FIG. 4 also apply with the exception that a physical gift card, rather than a, VPC, is used.

In a practical application of still other implementations, a sporting event, such as a professional hockey game being played at a large urban stadium, can be used as a venue sell to the game's attendees tickets to a raffle contest in which each ticket that is purchased has one (1) chance to win a cash prize in the amount of fifty percent (50%) of the ticket sales. To purchase a ticket, a game attendee uses their smart phone to access a website, enter payment information, and receive back a number that corresponds to one (1) chance to win the cash prize. After purchasing the ticket, the purchaser's smart phone receives a communication that include information to give the purchaser access to an inactive VPC. The communication includes instructions for the purchaser to log-in (or sign-up and log-in) to a particular website in order to active their inactive VPC. Upon activation of the inactive VPC, the VPC will be funded by a sponsor for a particular value. Stated otherwise, upon the VPC holder logging in to the website, the VPC is loaded with an amount (a set amount or randomly selected amount) and the VPC is activated for purchases at a whitelist of merchants. Note that the money that is loaded on each of the activated VPC may be provided by a sponsor of the raffle contest. During the hockey game, one (1) number is drawn by chance, where the number drawn corresponds to one (1) raffle ticket that had been sold at the website for this particular professional hockey game. The attendee who purchased the winning raffle ticket wins fifty percent (50%) of the ticket sales for this particular professional hockey game. Moreover, the VPC held by the attendee who purchased the winning raffle ticket will have fifty percent (50%) of the ticket sales automatically loaded onto their VPC. Alternatively, that VPC may be made to be operable at any merchant retail store, and not just those merchants who are on the whitelist. Also, the system may be configured such that the attendee who purchased the winning raffle ticket need not login to activate their VPC.

Referring to FIG. 5, Donation Audit Web Service 514 receives the information that was derived from the authorization response from Acquired Account Payment Processing System (z) 105, where each of the Issuer (j) 704, the Account Holder (p) 708, and the Merchant (m) 710 operate in Acquired Account Payment Processing System (z) 105.

Once confirmation has been received by Donation Audit Web Service 514 that a timely transaction has taken place been with a merchant, Method 400 moves to step 418 where a calculation is made of an amount of a donation that is to be made by the merchant according to terms of a merchant-defined donation. By way of example, the terms of the offer to make the donation to the community Affinity Entity may have been previously input for storage in Merchant DBs 580 (at data storage device 50 or merchant system 40 seen in FIGS. 10-13) by way of the merchant's user interface provided by an application executing on a computing device. To give notice of the donation obligation that now has arisen, the calculated donation can be sent in one or more transmissions from Donation Audit Web Service 514 to one or more logical addresses such as: (i) the Merchant in the third set who transacted with the customer; (ii) the Affinity Entity corresponding to the Residential Community. Optionally, information that identifies the Affinity Entity; and/or (iii) the Customer can be included in any such transmission.

Where the Affinity Entity to which the merchant is to obligated by the timely transaction to make a donation is specified by the customer, (e.g., such as by use of a user interface having a screen shot 304 seen in FIG. 3b as described above), the identity of the Affinity Entity need not be communicated to the merchant. Rather, the merchant can make a blind donation of the calculated amount to a third party for distribution to the Affinity Entity in the customer's residential community. By such blind, albeit obligatory, donations, conflicts and disagreements between customer and merchant as to right and proper objects of charity to the community can be avoided. As such, the customer may transact with community merchants by way of incentives from the community merchants that they will donate to the customer's favorite community charity (e.g., Affinity Entity), though the charity may not be the merchant's favorite charity, or even a desirable charity, in that community. Nevertheless, the merchant has received the benefit of a first set of customers' foot traffic inside the local brick and mortar store, as well as the benefit of a sub-set of the first set of customers that also conduct a transaction with the merchant, where each such benefit is realized by the merchant's offer to make a donation to the customer's favorite local charity(ies) if a timely transaction occurs subsequent to the offer.

Referring again to FIG. 5, by way of explanation for the nomenclature of reference numerals used and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer c can have a value from 1 to C, etc. As such, drawing elements 505, 508a-c, 510, 576-590 and 596 in FIG. 5 are illustrated with a block, but indicate that one or more elements can be present. For example, Affinity Entity (k) 596 is one of a possible plurality of affinity entities, where k may range from 1 to a large integer.

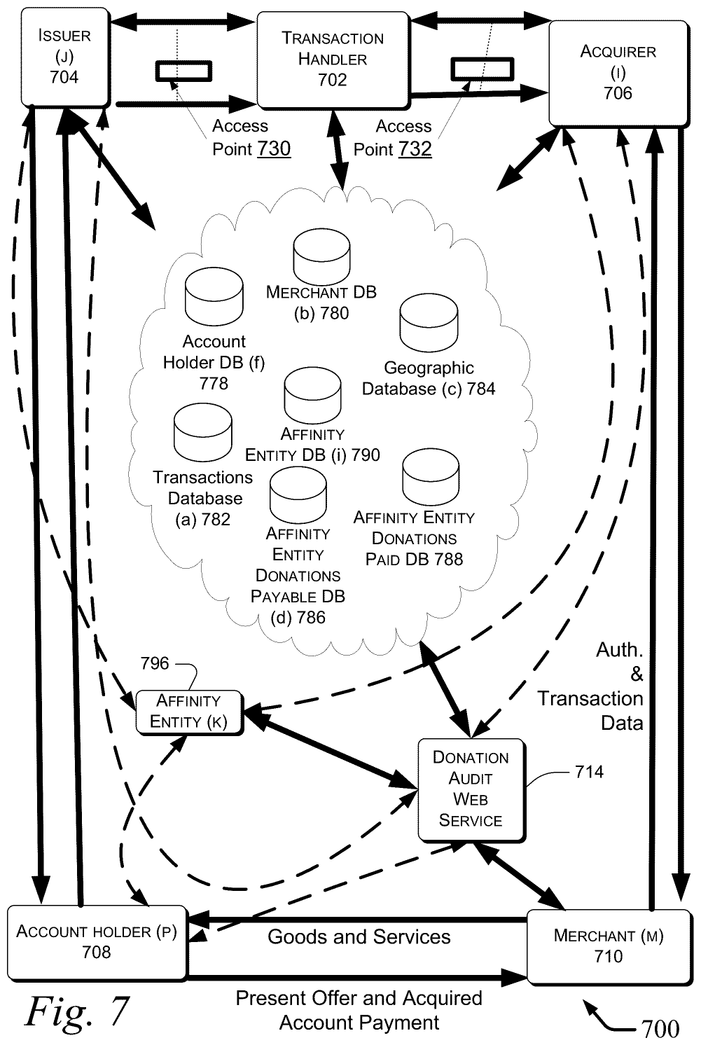

The diagram of FIG. 5 depicts an exemplary environment 500 for operation of Acquired Account Payment Processing System (z) 505. Alternative environments are shown in FIGS. 7, 10 to 13. Although different references may be used to refer to the various system components, the components of FIG. 5 may relate to the components shown in FIGS. 7, 10 to 13. Different system configurations may also be used and the various system configurations shown in the Figures are illustrative examples.

In environment 500, an account holder (p) 508a uses a mobile device (q) 508b and its Cellular Telephony Carrier (r) 508 to input VPC data in order to conduct an online transaction with a merchant. Alternatively, Account Holder (p) 508a may navigate to the brick and mortar store of a Merchant (m) 510 who then inputs the VPC data in order to conduct the online transaction with Account Holder (p) 508a using the VPC data. In some embodiments, a digital file containing the merchant address or directions may be transmitted to the mobile device for provision (verbally or otherwise) to account holder. The digital file may be used by a navigation system to direct the account holder to the merchant store, for example.

The transaction may be conducted on the VPC account issued by an issuer of such accounts within an Acquired Account Payment Processing System (z) 505, or other such as system as provided by the environment 700 illustrated in FIG. 7. Confirmation of the transaction may be received by Donation Audit Web Service 514 from Acquired Account Payment Processing System (z) 105. This confirmation obligates Merchant (m) 510 to make a donation to Affinity Entity (k) 596 according to the terms and conditions of the offer made by Merchant (m) 510 that was selected and confirmed by Account Holder (p) 508a. Stated otherwise, the Account Holder (p) 508a's financial transaction with the Merchant (m) 510 may have been incentivized by the Merchant (m) 510's agreement to make a donation to an Affinity Entity (k) 596 in their shared local community.

To conduct the transaction that triggers the donation by merchant (m) 510 to Affinity Entity (k) 596, as shown in FIG. 5, Account holder (p) 508 may present the VPC data incident to an online transaction with Merchant (m) 510 as tender for a financial transaction such as a purchase of goods and/or services. As part of the transaction, the Account Holder (p) 508a may offer a physical or virtue token bearing an identifier for the VPC with which the Account Holder (p) 508 is associated, where the token represents the VPC. The token can be read by a reader operated by the Merchant (m) 510, which as a reader associated with a Point of Service terminal (POS). For example, the reader might read the identifier for the Account Holder (p) 508a from a QR code representative of the VPC, or the token of the VPC may be communicated to Merchant (m) 510 via a rendering on a display screen of a cellular telephone or Personal Digital Assistant (PDA), a Near Field Communication (NFC) transmission, etc.

Also shown in FIG. 5 are one or more affinity Entities (k) 596 and a Donation Audit Web Service 594 that may implement processes for the auditing of donations to the one or more Affinity Entities (k) 596 from various donors, for instance, the Merchant (m) 510 and the Account Holder (p). The Donation Audit Web Service 594 may have access to information resources within the following databases: one or more Account Holder Databases (f) 578, where ‘(f)’ is an integer from 1 to ‘F’, that stores information about each Account Holder (p) 508, one or more Merchant Databases (b) 580, where ‘(b)’ is an integer from 1 to ‘B’, that stores information about each Merchant (m) 510, one or more Transaction Databases 582, where ‘(a)’ is an integer from 1 to ‘A’, that stores information about transactions between each Merchant (m) 510 and each Account holder (p) 508, and one or more Geographic Databases (c) 584, where ‘(c)’ is an integer from 1 to ‘C’, that stores information about local communities with which the Account Holders 508 and the Merchants 510 and the Affinity Entities 596 can be associated through any of several different associations. By way of example, and not by way of limitation, construction of such associations (e.g., local communities) can include factors such as geographic, political, demographics, local transportation modes, navigational algorithms for geopolitical regions, cartographic data, planned communities, population density, cultural divides, racial population constituencies, census statistics, socio-economic factors, and combinations thereof.

Also seen in FIG. 5 are one or more Affinity Entity Databases 590, where ‘(i)’ is an integer from 1 to ‘I’, to store information about each Affinity Entity (k) 596, one or more Affinity Entity Donations Payable Databases 586, where ‘(d)’ is an integer from 1 to ‘D’, to store information about currency amounts of donations that are obligations that are to be paid by specific donors to each Affinity Entity (k) 596, and one or more Affinity Entity Donations Paid Databases 588, where ‘(e)’ is an integer from 1 to ‘E’, to store information about currency amounts of donations that have been made by donors to each Affinity Entity (k) 596 from each Merchant (m) 510. Affinity Entity Databases may be stored at data storage device 50 or at affinity system 60 (FIGS. 10 to 13), for example.

Databases 578-590 (e.g. at data storage device 50) can be connected by one or more private or public networks, virtual private networks, the Internet, or by other means known to those skilled in the art. Moreover, not every entity seen in FIG. 5 at reference numerals 508, 510, and 596 must necessarily have real time, uninterrupted access to any or all of the Databases 578-590. Each such Databases 578-590 can assign, read, write, and query permissions as appropriate to the various entities. For example, a Merchant (m) 510 may have read-only access to the Transactions Database (a) 582.

Each of the one or more Transactions Databases (a) 582 can be used to store some or all of the transaction data originating at the Merchants (n) 510 for each transaction conducted between an Account holder (p) 508a and the Merchant (m) 510. The transaction data can include information associated with an identifier for the Account holder (p) 508a and the date and time of the transaction, among other more specific information including the amount of the transaction. The database can be searched using identifiers for the Account holder (p) 508a and the Merchant (m) 510, date and time (or within proximity thereof), or by any other field stored in the database.

Transactions Database (a) 582 can be designed to store information about each Merchant (m) 510, where the information can include a unique identification of each Merchant (m) 510, an identifier for each point of sale device in use by the Merchant (m) 510, and a physical geographic location of each store of the Merchant (m) 510. Also included in the Transactions Database (a) 582 is an identifier for Account holder (p) 508a, its Mobile Device (q) 508b, its Carrier (r) 508c, as well the name of an account holder who is registered to participate in a system in which donations can be made to each Affinity Entity (k) 596 as per rules stored in at least one of the Account Holder DB (f) 578 and Merchant DB (b) 580. This information may also be stored in various configurations, such as part of records 42, 54, 56, 58 at data storage device 50.

After activating the VPC, an Account holder (p) 508 initiates an online transaction to make a qualifying purchase from a Merchant (m) 510 by presenting a token bearing an identifier representative of the VPC. The token can include both an identifier for an account issued for the VPC to the Account Holder (p) 508a. The token can be presented online at a webpage or at the Point Of Service terminal (POS), such as POS 220 seen in FIG. 2, where the POS is capable of reading data on the token or receiving input of the VPC data. Certain transaction information is transmitted from the POS in route to the Donation Audit Web Service 594. The transaction information can include a transaction time stamp, respective Merchant (m) 510, Account Holder (p) 508a, and offer identifiers, as well as indicia that payment for the transaction was made on an account issued to the Account Holder (p) 508a.

The Donation Audit Web Service 594 may use the respective merchant and account holder identifiers to access and retrieve respective merchant and account holder geographic locations from one or more of the Geographic Databases 584. For each transaction, determinations are made, using the respective merchant and account holder geographic locations, whether the Merchant (m) 510 and the Account Holder (p) 508 have a local community in common, and whether the transaction is being conducted within a predetermined time period using the time of the transaction time stamp and the offer identifier. Note that the expiry of the offer may be retrieved from one or more of the Merchant DBs 580 assessable to the Donation Audit Web Service 594, which contains offers, their terms, and their corresponding offer identifiers.

For each authorized transaction between the Merchant (m) 510 and the Account Holder (p) 508, the Donation Audit Web Service 594 retrieves a merchant donation business rule for the Merchant (m) 510. Note that the merchant donation business rule can be retrieved from one or more of the Merchant DBs 580 (at data storage device 50, or merchant system 30) assessable to the Donation Audit Web Service 514, which contains merchant business rules and their corresponding merchant identifiers.

From the foregoing, a determination is made by the Donation Audit Web Service 514 that the Merchant (m) 510 is to make a donation to Affinity Entity (k) 596 which has been determined to have the same local community as that of the Account Holder (p) 508a and Merchant (m) 510. Note that the Affinity Entity (k) 596 can be retrieved from one or more of the Affinity Entity DBs 590 assessable to the Donation Audit Web Service 594 which contains information about Affinity Entity (k) 596 indexed by its corresponding affinity entity identifier.

The donation to be made by the Merchant (m) to the Affinity Entity (k) 596 may be derived using the merchant's donation business rule retrieved from one or more of Merchant DBs 580. Donation Audit Web Service 514 transmits a message containing the donation to be made by the Merchant (m) to the Affinity Entity (k) 596 for the predetermined time period to one or more logical addresses, including a logical address of the Merchant (m) 510, a logical address of the Account Holder (p) 508a, and a logical address of the Affinity Entity (k) 596. It is advantageous to send the donation to the logical address of the Account Holder (p) 508a to confirm the obligation of the Merchant (m) 510's commitment to donate. It is advantageous to send the donation to the logical address of the Affinity Entity (k) 596 to inform the same of the Merchant (m) 510's commitment to donate so that planning for responsible use of the donation can be made. Alternatively, for reasons stated herein, while it is advantageous to send the amount of the donation to the logical address of the Merchant (m) 510 to inform the same of its commitment to donate, it might not be advantageous to send the identity of the donee to the donor who may object to the donation on the basis of the donee's identity, purpose and/or goals. Accordingly, a message sent to the logical address of the Merchant (m) 510 need not identify the Affinity Entity (k) 596, and can instead simply send the amount of the donation to the logical address of the Merchant (m) 510.

After a predetermined audit time period for each offer's validity, for each of the merchant identifiers to which transactions pertain as described above, for each Affinity Entity (k) 596 to whom a donation was to be made by the Merchant (m) 510 for the predetermined time period—either directly or through a blind donation distribution service, the Donation Audit Web Service 514 determines a difference between the sum of the currency amounts of the donation receipts that were transmitted to the logical address of the Merchant (m) 510 for the Affinity Entity (K) 596, and the sum of the currency amounts of the donation receipts that were received for the Affinity Entity (K) 596 for the Merchant (m) 510 for the predetermined time period. Any such difference can then be transmitted to a logical address that is one or more of the logical address of the merchant, the logical address of the account holder, and the logical address of the affinity entity. It is advantageous to send confirmation of the sum of its donations to the logical address of the Merchant (m) 510 to confirm compliance with its prior commitments to donate. It may be advantageous to send a summary of donations made by merchants with whom the Account Holder (p) 508a has transacted in order to confirm to the Account Holder (p) 508 the community advantages of doing business with community merchants, where such a summary of merchant donations can be sent to the logical address of the Account Holder (p) 508, thereby informing the same of the integrity of the community merchant's commitment to donate to the community. It may be advantageous to send the summary of donations to the logical address of the Affinity Entity (k) 596 to inform the same as to the completion, or absence of completion, as to obligations made by community merchants regarding their respective commitments to donate to the local community of the Merchant (m) 510 and Account Holder (p) 508a.

A computed and unacceptably high difference that is sent to the logical address of the Merchant (m) 510 can be used the Merchant (m) 510 to make up the difference by a payment made by the Merchant (m) 510 directly to the Affinity Entity (k) 596 owed. Alternatively, the difference payment may be made indirectly to a blind donations disbursement agency for subsequent payment of the difference to the Affinity Entity (k) 596 to whom the Merchant (m) 510 made a commitment, albeit a blind commitment, to contribute.

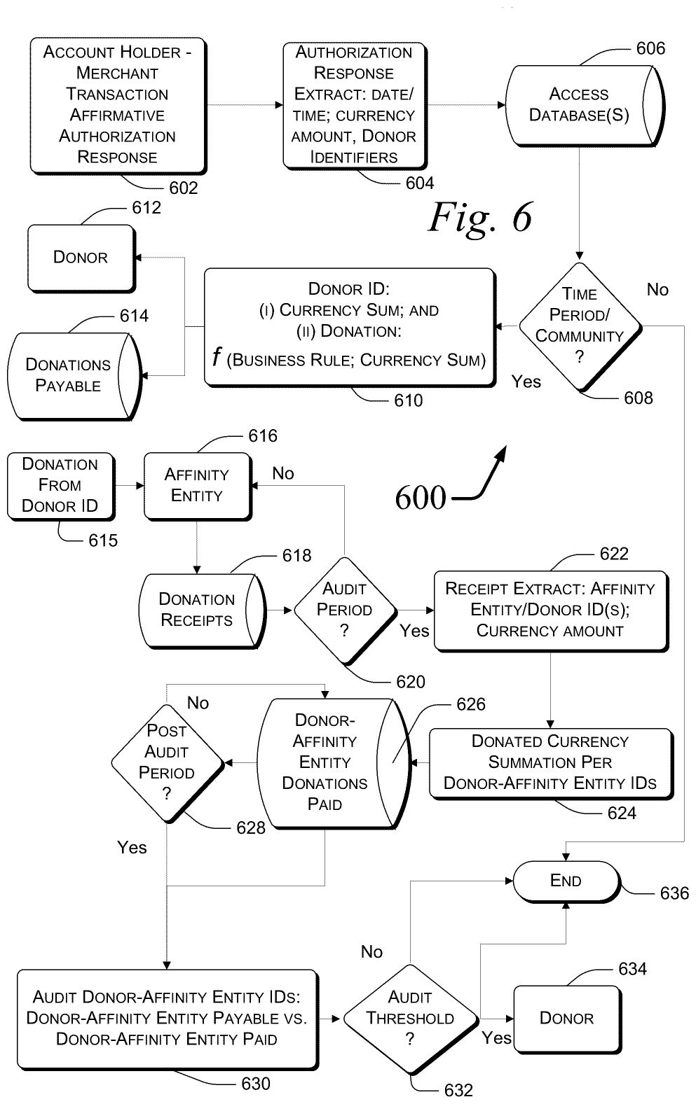

Referring to FIG. 6, a flowchart illustrates a Process 600 that can be performed by a system (e.g. FIGS. 5, 7, 10-13), such as Donation Audit Web Service 214/514/714, for using local merchants' commitments to make charitable contributions to local charities as incentives to local residents to conduct transactions with the local merchants. Prior to step 602 of Process 600, as discussed above with respect to FIGS. 1-5, a registered local community resident conducts a transaction on a VPC corresponding to a BIN of an account.

At step 602, information is received as derived from a positive authorization response originating from an issuer of an account for a VPC upon which the online transaction was conduct by user of a web access device with a merchant as describe above with respect to FIGS. 1-5. Data from this information can be extracted at step 604 by a POS, including, by way of example and not by way of limitation, the current date and time, a total currency amount paid on the customer's account to the merchant, respective identifiers for the customer, the local affinity entity to whom the local merchant if to make the obligatory donation, etc.

Identifiers retrieved at steps 602-604 can be used to access one or more databases (at data storage device 50) at step 606. The current date and time for the online transaction At step 610, rules for calculating a donation to be made by the merchant to the local affinity entity may be retrieved using data acquired in steps 602-604. This calculation can include steps to access one or more databases as shown at reference numerals 612-614, including transmitting to and/or storing the calculated donation to merchant donor 612 and/or one or more merchant donations payable databases 614.

Subsequent to the acquired transaction on the resident's account as processed in steps 602-614 of Process 600, the local merchant makes the calculated donation to the local affinity entity as shown at step 615. The local affinity entity, as shown at step 616, sends notice of the donation's receipt for storage in one or more databases (e.g. at data storage device 50) as shown at step 618.

After a predetermined audit time period as passed as determined by a query at step 620, an audit is conducted to ensure compliance by each community merchant in its donation commitments to each of the one or more affinity entities or charities for each community that the merchant and/or its customers is a member. This audit can include adding up all required donations for each local merchant to each local affinity entity or charity as shown at step 622. The donation summation for each local merchant to each local charity derived at step 624 is compared to information in one or more databases 626 to ascertain compliance of each merchant with its donation obligations. Stated otherwise, the local merchant has a certain amount of time after a predetermined audit period, as determined at step 628, by which to make all of the merchant's donation obligations to local affinity entities.

Differences between donations paid and donations still payable by each local merchant are calculated at step 630, which differences are subjected to an audit threshold query at step 632. If a local merchant's donations paid is non-compliant with donations still payable, as may be determined by the audit threshold query at step 632, then Process 600 moves to step 634 to notify the local merchant accordingly of its deficiency. Otherwise, affirmative results at query 632 causes Process 600 to terminate at step 636 which may also include notice of compliance being transmitted to each such complaint local merchant, its customers, and/or each of the local affinity entities, either by way of summary report, donations to respective affinity entities by the merchant, and variations thereof.

To summarize Process 600 in various implementations thereof, data is extracted from information derived incident to a positive authorization response for an acquired transaction conducted on a local resident's account, such as chronological information pertaining to the transaction including date and time, a currency amount of the transaction, and any other data desired to assist in a proper calculation of the merchant's obligatory donation to a local Affinity Entity. By way of example, an identifier for the merchant can be extracted, as well as an identifier for the local community resident as offered to the merchant by the same. The account number for a VPC, by way of non-limiting example, can be a Primary Account Number (PAN) including a Bank Identifier Number (BIN) code for a card that is kept by the merchant in a ‘card-on-file’ database

Note that the business rules can be set and used such that obligatory donations to local Affinity Entities can be made by one or more of the following participants in a payment processing system: the account holder, the account holder's issuer, the merchant, the merchant's acquirer, and the transaction handler. Via access to one or more databases at step 606, and by using the merchant and/or account holder identifiers extracted from the information derived from the positive authorization response, more information can be retrieved. Thereafter, database access can retrieve business rules used to calculate one or more donations that are to be made to the charity or affinity entities by one or more donors respectively corresponding to the account holder, the account holder's issuer, the merchant, the merchant's acquirer, and the transaction handler. Stated otherwise, the donation can be a function of the amount of the transaction and the retrieved business rule(s).

Donations, per extracted donor IDentifier (ID), may be made for those transactions that occur during a predetermined time period and within a predefined geographic location as determined by a query (not shown). If the result of geographic query is affirmative, process 600 moves to step 610 where the donations that are to be made by the donors are calculated as a function of the respective business rules. Otherwise, no donation is made and process 600 terminates at step 636. Stated otherwise, Process 600 is intended to obligate a local merchant to make a donation to a local affinity entity (e.g., a local charity) when a local resident conducts a transaction at the local merchant's brick and mortar store in the same community where the local resident resides. Note that the terms ‘local’, ‘resident’, ‘residential’, and ‘community’ can be alternatively defined as described elsewhere herein.

Donations calculated at step 610 may be communicated to the merchant donor at step 612 and stored in a donations payable database 614. Thereafter, donations 615 may be received at affinity entities at step 615 from donors identified by either respective donor IDs, which can be the identifier for the merchant. Donations received are stored in donation receipts database 618. Data from donations that are made by donors via communication to affinity entities during an audit period, as determined at query 620, is extracted at step 622. The donation related data that is extracted at step 622 can include the donor ID, and the currency amount of the donation. During the audit period, a sum of donations to each affinity entity made by each local merchant donor for the audit period is calculated and stored in a donor-Affinity Entity donation paid database 626 (e.g. at data storage device 50). After a predetermined time period, an audit period begins, as determined by query 628. During the audit time period, differences in donations paid are compared to donations payable for each donor at step 630. Differences exceeding a predetermined audit threshold, as determined by query 632, are communicated to the respective local merchant donors at step 634. Of course, the charitable audit functions, such as have been described above, can be performed by an agent of any donor and/or of a loyalty system organization charged with implementing all or portions of process 600. Such an auditing agent can be, by way of non-limiting example, a certified public accountancy agency, a non-government regulatory agency, a governmental agency, and the like.

As further discussed above with respect to various implementations, a donation mechanism can be set up such that the Merchant-Donor 634 makes blind donations, either directly or indirectly, to a single donation disbursement entity who in turn disburses the donations to those affinity entities selected by the customers of the Merchant-Donor 634. This donation mechanism provides neither knowledge nor notice to Merchant-Donor 634 as to the identities of its donation recipients, thereby avoiding circumstances that force a merchant, by virtue of its prior commitment, to make a donation to a local community affinity entity whose role, or purpose is inimical or otherwise repugnant to the Merchant-Donor 634. As such, the donation mechanism leaves the direction of the donations fully within the discretion of the customers, limited only by the restriction that the customer can only select from among those affinity entities that serve the local community that is in common to both the customer and the Merchant-Donor 634, while leaving the actual amount of the donation fully within the discretion of the Merchant-Donor 634.

The diagram of FIG. 7 depicts an exemplary process 700 of a particular financial transaction system, such as may be described as an open loop system, in which an account holder (p) 708 conducts a financial transaction with a Merchant (m) 710. By way of example, the Account Holder (p) 708's financial transaction with the Merchant (m) 710 may have been incentivized by the Merchant (m) 710's agreement to make a donation to an Affinity Entity (k) 795 in the local community as defined by the Merchant (m) 710, preferably by use of a web access device as described above with respect to illustrations in FIGS. 1-6, and as referred to in FIGS. 10 to 13 as customer device 48.

In FIG. 7, by way of explanation for the nomenclature of reference numerals used and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer c can have a value from 1 to C, etc. As such, drawing elements 704-710 and 776-790, and 796 in FIG. 7 are illustrated with a block, but indicate one or more elements can be present. For example, Issuer (j) 704 is one of a possible plurality of issuers, where j may range from 1 to a large integer ‘J’.

Account Holder (p) 708 presents a VPC in an online transaction with a Merchant (m) 710 as tender for a financial transaction such as a purchase of goods and services. As part of the transaction, the Account Holder (p)'s 708 VPC data can be communicated via web access device cellular telephone, Personal Digital Assistant (PDA), etc. Thereafter, a request for authorization is transmitted to the Merchant (m) 710's Acquirer (i) 706. Each Acquirer (i) 706 is a financial organization that processes VPC transactions for businesses, for example merchants, and is licensed as a member of a Transaction Handler 702 such as a credit card association (i.e., Visa Inc., MasterCard, etc.) As such, each Acquirer (i) 706 establishes a financial relationship with one or more Merchants (n) 710.

The Acquirer (i) 706 transmits the account information to the Transaction Handler 702, who in turn routes the authorization request to the account holder's issuing bank, or Issuer (j) 704. The Issuer (j) 704 returns information via an authorization response to the Transaction Handler 702 who returns the information to the Merchant (m) 710 through the Acquirer (i) 706. The authorization response will contain information pertaining to the result of the Issuer (j) 704 validating: (i) the transaction amount vs. the VPC's stored value; and (ii) the Merchant's M-ID vs. M-ID White List. The Merchant (m) 710, now knowing whether the Account Holder (p) 708's VPC account is valid and supports a sufficient store value balance, may complete the transaction and the Account holder (p) 708 in turn receives goods and/or services in exchange.

To reconcile the financial transactions and provide for remuneration, information about the transaction is provided by the Merchant (m) 710 to Acquirer (i) 706, who in turn routes the transaction data to the Transaction Handler 702 who then provides the transaction data to the appropriate Issuer (j) 704. The Issuer (j) 704 then provides funding for the transaction to the Transaction Handler 702 through a settlement bank. The funds are then forwarded to the Merchant's (n) 710 Acquirer (i) 706 who in turn pays the Merchant (m) 710 for the transaction conducted at step 762 less a merchant discount, if applicable. The Issuer (j) 704 then bills the Account holder (p) 708, and the Account holder (p) 708 pays the Issuer 704 with possible interest or fees.

Also shown in FIG. 7 are one or more Affinity Entities (k) 796 and a Donation Audit Web Service 714 that implements processes by which donations to the one or more Affinity Entities (k) 796 from various donors, for instance, any Issuer (j) 704, an Merchant (m) 710, any Acquirer (i) 706, and the Transaction Handler 702. Other system configurations may be used, such as the illustrative examples shown in FIGS. 10 to 13. Donation Audit Web Service 714 implementations processes for the auditing of donations to the one or more Affinity Entities (k) 796. The Donation Audit Web Service 714 has access to information resources within the following databases: Account Holder DBs 778; Merchant DBs 780; Transaction Databases 782; and Geographic Databases 784. These databases may be persistently stored at data storage device 50.

By way of example, and not by way of limitation, construction of local, geographic, residential or community associations between merchants and their customers can include factors such as geographic, political, demographics, local transportation modes, navigational algorithms for geopolitical regions, cartographic data, planned communities, population density, cultural divides, racial population constituencies, census statistics, socio-economic factors, and combinations thereof.

Also seen in FIG. 7 are Affinity Entity DBs 790; Affinity Entity Donations Payable DBs 786; and Affinity Entity Donations Paid DBs 788. Databases 778-790 can be connected by one or more private or public networks, virtual private networks, the Internet, or by other means. These databases may be persistently stored at data storage device 50. Moreover, not every entity seen in FIG. 7 at reference numerals 708, 710, and 796 must necessarily have real time, uninterrupted access to any or all of the Databases 778-790 at data storage device 50. Each such Databases 778-790 can assign, read, write, and query permissions as appropriate to the various entities. For example, a Merchant (m) 710 may have read access to the Transactions Database (a) 782.

The Transactions Database (a) 782 can be designed to store some or all of the transaction data (e.g. transaction data 58 at data storage device 50) originating at the Merchants (n) 710 that use a payment device for each transaction conducted between an Account holder (p) 708 and the Merchant (m) 710. The transaction data can include information associated with the account of an Account holder (p) 708, date, time, and an identifier sufficient to determine a physical geographic location where the transaction took place, among other more specific information including the amount of the transaction. The database can be searched using account information, date and time (or within proximity thereof), or by any other field stored in the database.

The Transactions Database (a) 782 is also designed to store information about each Merchant (m) 710, where the information can include a unique identification of each Merchant (m) 710, an identifier for each point of sale device in use by the Merchant (m) 710, and a physical geographic location of each store of the Merchant (m) 710.

Also included in the Transactions Database (a) 782 is account information for VPCs associated with Account holder (p) 708, such as part or all of an account number, unique encryption key, account information, and account name of an account holder who is registered to participate in a system in which donations can be made to each Affinity Entity (k) 790 as per rules stored in Donations Business Rule Database (b) 780. After registering to participate in the donation system, an Account holder (p) 708 initiates a qualifying purchase transaction with a Merchant (m) 710 by presenting a VPC in an online transaction at step 758 to the Merchant (m) 710. Certain transaction information is transmitted from the POS in route to the Merchant's (n) 710 Acquirer (i) 706. The transaction information can include account information, account name, transaction balance, transaction time, transaction date, and transaction location. Sensitive information includes information such account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the Merchant (m) 710, and the ultimate destination, such as the Acquirer (i) 706. These points can include, without limitation, from the reader at the POS, the POS at the Merchant (m) 710 and a network router or computer that is connected to a network but is housed and maintained by the Merchant (m) 710 and between the Merchant (m) 710 and the Acquirer (i) 706. The communication channel could be Ethernet, wireless internet, satellite, infrared transmission, or other known communication protocols. Some or all of the transmission may also be stored for record keeping, archival or data mining purposes with little or no encryption. For example, the Merchant (m) 710 may store transaction data, including certain account information in the Merchant's (n) 710 accounts on file database for reuse later.

During a transaction conducted by Merchant (m) 706 on an account issued by Issuer (j) 704 to Account Holder (p) 708, information relating to the qualifying purchase may be retrieved from the POS at Merchant (m) 706. The transaction information is comprised of account information together with other information about the transaction itself: time, date, location, value, etc. Certain of the transaction information are considered sensitive information including, without limitation, VPC account number, verification number, and account name.

To pay the donation to each Affinity Entity (k) 796 so specified in screen shot 304, the Account Holder (p) 708's Issuer (j) 704 can pay the Affinity Entity (k) 786 and place a debit in that currency amount on the Account Holder (p) 708's periodic revolving credit statement. The Account Holder (p) 708, upon receipt of the statement, can thereafter make a total payment to the Issuer (j) 704 of the currency amount of the donation that appears as a debit on the statement along with the other credit charges that also appear on the Account Holder (p) 708's statement.

Both the Account Holder (p) 708 and the Merchant (m) 710 can change or disable a donation commitment at any time by accessing a server that serves a web page rendering of screen shot 304. Thus, charitable donation commitments can be easily and instantly enabled or disabled using the real time user interface. By way of example, and not by way of limitation, such servers can be hosted by the Donation Audit Web Service 214, 514, and 714 seen in FIGS. 2, 5 and 7, respectively.

Referring again now to FIG. 7, further illustrations are seen of a telecommunications network that may make use of any suitable telecommunications network and may involve different hardware, different software and/or different protocols then those discussed below. FIG. 7 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice—the first time with only information needed for an authorization decision, an again later with additional information for clearing and settlement. A single message transaction is sent once for authorization and contains clearing and settlement information as well. Typically, authorization, clearing and settlement all occur on-line.

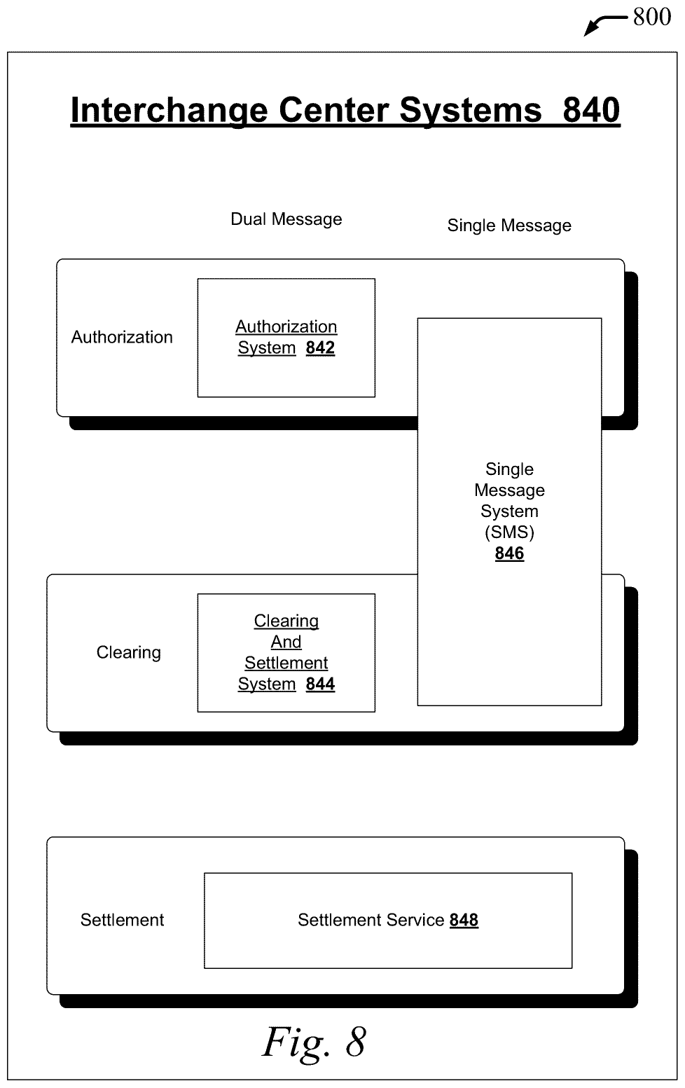

Referring now to FIGS. 7-9, FIG. 7 includes access points 730, 732 between Transaction Handler 702 and each Acquirer (i) 706 and Issuer (j) 704. Other entities such as drawee banks and third party authorizing agents may also connect to the financial; network through an access point (not shown). An interchange center has systems, such as those seen at reference numeral 840 see in FIG. 8, so as to be a data processing center that may be located anywhere in the world. Each interchange center houses the computer system that performs the network transaction processing. The interchange center serves as the control point for the telecommunication facilities of the network, which comprises high-speed leased lines or satellite connections, for instance as may be based on IBM SNA protocol. Preferably, the communication lines that connect an interchange center (Transaction Handler 702) to remote entities use dedicated high-bandwidth telephone circuits or satellite connections, for instance as may be based on the IBM SNA-LUO communication protocol. Messages are sent over these lines using any suitable implementation of the ISO 8583 standard.

Access points 730, 732 may be made up of small computer systems located at a processing center that interfaces between the center's host computer and the interchange center system 840. The access point facilitates the transmission of messages and files between the host and the interchange center supporting the authorization, clearing and settlement of transaction. Telecommunication links between the Acquirer (i) 796 and its access point 732, and between the access point 730 and Issuer (j) 704 are typically local links within a center and use a proprietary message format as preferred by the center.

A data processing center (such as is located within an acquirer, issuer, or other entity) houses processing systems that may support merchant and business locations and maintain customer data and billing systems. Preferably, each processing center may be linked to one or two interchange centers. Processors may be connected to the closest interchange, and if the network experiences interruptions, the network may automatically route transactions to a secondary interchange center. Each interchange center is also linked to all of the other interchange centers. This linking enables processing centers to communicate with each other through one or more interchange centers. In addition, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

FIG. 8 illustrates systems 840 housed within an interchange center to provide on-line and off-line transaction processing. For dual message transaction, authorization system 842 provides authorization. Authorization system 842 supports on-line and off-line functions, and its file includes internal systems tables, a customer database and a merchant central file. The on-line functions of system 842 support dual message authorization processing. This processing involves routing, account holder and card verification and stand-in processing, and other functions such as file maintenance. Reporting includes authorization reports, exception file and advice file reports, POS reports and billing reports. A bridge from system 842 to a Single Message System (SMS) 846 makes it possible for issuers and acquirers to use system 842 to communicate with other issuers and acquirers using system 546 and access the SMS gateways to outside networks.

Clearing and settlement system 844 clears and settles previously authorized dual message transactions. System 844 collects financial and non-financial information and distributes reports between members. It also calculates fees, charges and settlement totals and produces reports to help with reconciliation. A bridge forms an interchange between system 844 processing centers and system 848 processing centers. Data from system 800 may be stored as part of transaction data 58 (at data storage device 50 of FIG. 10)

Single message system 846 processes full financial transactions and can also process dual message authorization and clearing transactions, as well as communicate with system 842 using a bridge and accesses outside networks as required. System 846 processes cashless issued account-based acquired transactions, for instance Visa, Plus, Interlink. Maestro, Cirrus, and others. By way of example, SMS files comprise internal system tables that control system access and processing, and an account holder database, which contains files of account holder data used for Personal IDentifier (PIN) verification and stand-in processing authorization. System 846 has on-line functions that perform real-time account holder transaction processing and exception processing for authorization as well as full financial transactions. System 846 also accumulates reconciliation and settlement totals. System 846 also has off-line functions that process settlement and funds transfer requests and provide settlement and activities reporting. Settlement service 848 consolidates the settlement functions of system 844 and 846 for cashless issued account-based acquired transactions into a single service for all products and services. Clearing continues to be performed separately by system 844 and system 846.

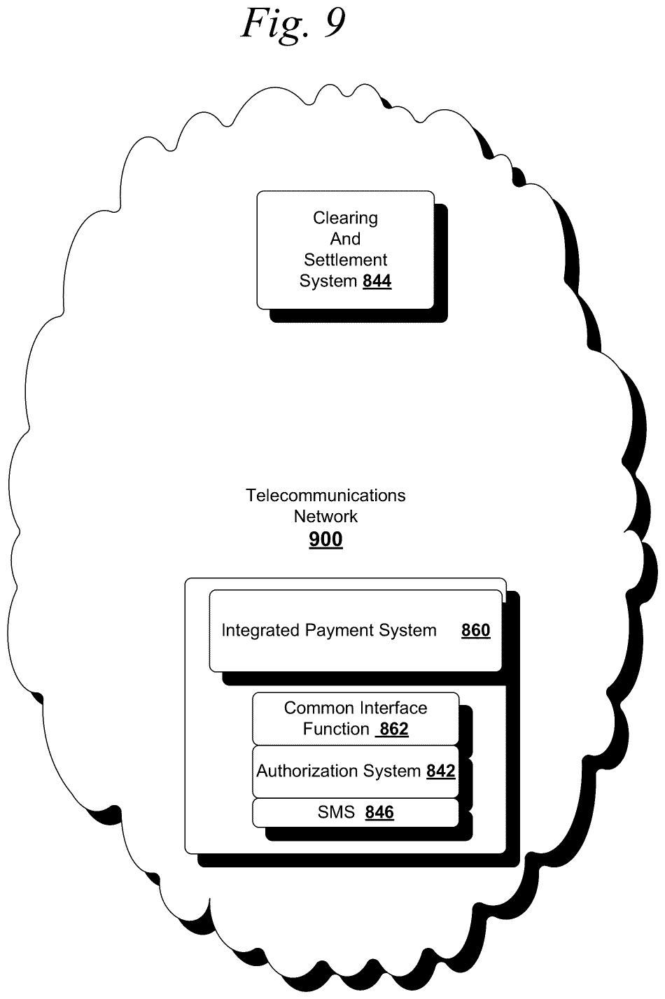

FIG. 9 illustrates another view of components of FIG. 8 in a telecommunications network 900. Integrated payment system 960 is the primary system for processing all on-line authorization and financial request transactions. System 960 reports both dual message and single message processing. In both cases, settlement occurs separately. The three main software components are the common interface function 962, authorization system 942 and single message system 946.

Common interface function 962 determines the processing required for each message received at an interchange center. It may choose the appropriate routing, based on the source of the message (system 942, 944 or 946), the type of processing request and the processing network. This component may perform initial message editing, and, when necessary, parses the message and ensures that the content complies with basic message construction rules. Common interface function 962 routes messages to their system 942 or system 946 destinations.

Referring again now to FIGS. 2, 5, and 7-9, further illustrations are seen of a telecommunications network that may make use of any suitable telecommunications network and may involve different hardware, different software and/or different protocols then those discussed below. FIGS. 2, 5, and 7-9 include a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process. The telecommunications network may also connect the components shown in FIGS. 10 to 13.

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

By way of example, the web enabled mobile device 102 seen in FIG. 1 communicates with a server, for example, Donation Audit Web Service 214 seen in FIG. 2. This may also extend to customer device 48 which may communicate with Donation Audit Web Service 214/514/714 seen in FIGS. 5, 7, 10 to 13. While the latter may be programmed using server-client coding methodologies, an application executing on the former can be a thin client mobile web browser or an application specific to perform implementations described herein. Such a specific application can be coded to execute on a mobile device running an open source operating system. For example, the Tizen operating system can be used as the operating system for the mobile device 102 seen in FIG. 1, which can be a smartphone, a tablet, an in-vehicle infotainment (IVI) device controller or “headunit”, or other web enabled mobile computing device.

Referring now to FIGS. 10 to 13, there is shown various system configurations in accordance with embodiments described herein. The components of systems shown in FIGS. 10 to 13 may correspond to one or more components shown in FIGS. 2, 5, 7.

Loyalty system 20 interacts with merchant system 40, data storage devices 50, an affinity system 60, a VPC issuer system 80/88, and a VPC holder and transaction data base 88 to process online transactions, collect data regarding online transactions, merchants, customers, affinity entities, process donations, transfer funds, and so on.

Loyalty system 20 may be implemented using a server and data storage devices 50 configured with database(s) or file system(s), or using multiple servers or groups of servers distributed over a wide geographic area and connected via a network. Loyalty system 20 may be connected to a data storage device 50 directly or via to a cloud based data storage device interface via network. Loyalty system 20 may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. Loyalty system 20 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Loyalty system 20 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. Loyalty system 20 may include one or more input devices, such as a keyboard, mouse, camera, touch screen and a microphone, and may also include one or more output devices such as a display screen and a speaker. Loyalty system 20 has a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one loyalty system 20 is shown for clarity, there may be multiple loyalty systems 26 or groups of loyalty systems 26 distributed over a wide geographic area and connected via e.g. network. Loyalty system 20 may be connected to the Internet or other network in order to interact and connect with merchant system 40, customer device 48 and affinity system 60.

Loyalty system 20 includes a VPC holder benefits (e.g. incentives) processing utility 32. A VPC holder may be a customer of merchant and a member of the loyalty program to receive incentives to transaction with the merchant. The loyalty program may be associated with a VPC issuer system 80/88. In one example of an implementation, the VPC holder benefits processing utility 32 may be a software component of a web utility that provides a loyalty engine. Accordingly, VPC holder benefits processing utility 32 may be referred to as a loyalty engine. The VPC holder benefits processing utility 32 may be programmed to configure the data storage device database 32 with benefits accounts 52 of the various VPC holders who are members of the loyalty program. The benefits accounts may comprise a record of incentives for the member, along with details of transactions associated with incentives and customer attributes and preferences (such as e.g. location data, preferred affinity entity data).

The loyalty system 20 may be programmed to configure the data storage device 50 with merchant accounts 54 of the various merchants who are registered with loyalty system 20 to provide loyalty programs and offer incentives or benefits to encourage cash payments and in-store transactions through donations to affinity entities. As described herein, the merchant accounts 54 may include a variety of information and attributes regarding different merchants, including locations, goods and services, offers, transactions, donations, and so on.

The loyalty system 20 may be programmed to configure the data storage device 50 with card or member accounts 56 who are registered with loyalty system 20 or with VPC issuer system 80/88 to provide loyalty cards to VPC holders for loyalty programs. The loyalty cards may be physical cards with computer readable indicia to identify the VPC holder, and may also be an electronic card for storage on storage device of mobile device or smart phone of VPC holder. The loyalty card may be associated with a value account for the merchant for payment of transactions with merchant. The VPC issuer system 80/88 may operate a loyalty program (via points and reward program utility 82) in conjunction with a loyalty program offered by loyalty system 20. Loyalty system 20 may provide a bridge between points and reward program utility 82 and merchant systems 40 and affinity systems 60. VPC holder registration utility 84 may enable a VPC holder to register with VPC issuer system 88, where data regarding the VPC holder may be stored as member accounts 56 at data storage device 50.

Access to different aspects and account records of the data storage device 50 may be provided by an administration utility (not shown) that enables hierarchical access to the data storage device 50, depending on permissions assigned by the operator of the loyalty system, to each of members, and merchants. The purpose of providing this access is to provide transparency to the benefits being provided to members who are VPC holders by operation of the loyalty system 20.

Loyalty system 20 further includes a reporting utility or transaction data reporting tool 38, which may be further linked to the VPC holder benefits processing utility 32 and data storage device 50 to provide various reports of interest to merchants and VPC holders. For example, transaction data reporting 36 may permit merchants to generate reports on measured performance of benefits or incentives provided to them by the loyalty system 20 in their sphere of interest. Merchant system 40 may receive the report via merchant interface 28 and merchant reporting tool 46. One of the purposes of the reporting utility 36 is to enable the organizations linked to the loyalty system 20 to calibrate their involvement (e.g. by merchants calibrating the benefits that they provide) targeted to VPC holders, and to review the results of their loyalty programs management by loyalty system 20. VPC issuer system 80/88 may similarly use a card issuer reporting tool 86 to access reports generated by loyalty system 20. Card issuer system 86 may provide VPC holder and transaction data 88 to loyalty system 20 regarding transactions and members for processing by data scrub utility 36 and storage by data storage device 50 as benefit accounts 52, member accounts 56, and transaction data 58.

Loyalty system 20 may include loyalty program module 22 which may be a hardware and software tool to manage the various loyalty programs managed by loyalty system 20. Loyalty programs may be particular to one or more merchants. A loyalty program may be used to provide incentives or offers to the customer or members.

In example embodiments described herein, merchant system 40 may be provided with tools to design and implement their own loyalty programs, design and implement their own benefits or incentives, including cross-promotional programs in conjunction with other merchants in the same community for example. The merchant system 40 may design and implement loyalty programs and incentives using merchant interface 28. Merchant system 40 may transmit merchant data (e.g. parameters for reports) to loyalty system 20 via merchant interface 28. Merchant system 40 may transmit customer and transaction data 44 (e.g. data regarding transactions and customers) to loyalty system 20 via merchant interface 28.

Similarly, in example embodiments described herein, VPC issuer system 80/88 may be provided with tools to design and implement their own loyalty programs, design and implement their own benefits or incentives, including cross-promotional programs in conjunction with other merchants in the same community for example. For example, points and rewards program utility 82 may interact with loyalty system 20 to manage loyalty programs for card issuers. VPC holder registration utility 84 may enable registration of VPC holders directly with VPC issuer system 80/88 or via loyalty system 20.

Each customer may be associated with a market or demographic, which may be used by merchant system 40 and loyalty system 20 to recommend customer incentives and offers. A loyalty program incentive may be used to target particular consumer needs. Loyalty system 20 may recommend incentives via recommendation engine 30 tailored to segments of customers, where the recommendation may be based attributes of customers, such as spending habits, interests, needs, wants, charities, social habits, current location etc. Loyalty system 20 may recommend affinity entities based on customer attributes or merchant attributes, such as location, partnerships, goods and services, spending trends, interests, needs, wants, charities, social habits, etc.

The loyalty system 20 is operable, via the Internet for example, to engage in real time data communications with a merchant system 40, VPC issuer system 88, and also customer or member devices 28 (e.g. electronic device, smart phone, mobile device, laptop, tablet, navigation system, IVI devices, or other computing device). Accordingly, seamless data flows between these systems can be established in order to enable the capture of financial transactions and VPC holder data, and also the accrual of benefits or incentives based on data provided to the loyalty system 20 the merchant system 40.

Loyalty system 20 is operable to provide system tools for the affinity system 60 to receive payments from the merchant systems 40 and card issuer systems 60 in connection with transactions between the merchants and the VPC holders registered with the loyalty system 20. The reporting facility provides visibility to the affinity entity, the VPC holders, the card issuers, and the merchant in regard to the amounts accrued and subsequently paid as donations at the end of the measurement period.

The loyalty system 20 may pre-determine the conditions under which this occurs. Typically, incentives or offers are associated with conditional transactions with merchants (e.g. the purchase of a particular good or service is required in order to receive the special offer or prize, cash payments, in-store transactions). This encourages VPC holders to conduct transactions with merchants. When a registered VPC holder enters into such a transaction with a merchant in connection with the loyalty system 20, a transaction amount is recorded. At the end of the reporting period the system aggregates the amounts for reporting purposes, and for calculating donations. Funds may distribute to the respective affinity systems 60.

Loyalty system 20 provides for a linkage of a data between merchant systems 40, card issuer systems 80, affinity systems 60, and VPC holders (via customer device 48). Although only one merchant system 40 is shown in FIG. 2 for simplicity, there may be multiple merchant systems 40 connected to loyalty system 20. Although only one VPC issuer system 80/88 is shown in FIG. 2 for simplicity, there may be multiple VPC issuer systems 80 connected to loyalty system 20.

Loyalty and customer acquisition programs may be required to continually acquire new members, preferably at a low cost, e.g. through organic growth or through a partnership with various customer sources. Loyalty system 20 may retain VPC holder databases of transaction information and other VPC holder benefits, which may include data from other participating merchants. Loyalty system 20 may access the VPC holder databases to detect VPC holder and member attributes in order to recommend incentives via recommendation engine 30. Benefit accounts 52 may include records of offers for various merchants, as described herein.

Transaction data 58 may include (1) customer name; (2) payment method; (3) date of transaction; (4) merchant ID; (5) amount of purchase; and (6) goods and services. Other information may also be accessible such as demographic and geographic information relating the VPC holder. This information may be stored in data storage devices 50 and accessed by loyalty system 20.

Loyalty system 20 enables each of the merchants and members to track the accrual of benefits by means of transactions that in connection with the loyalty system 20 result in the accrual of loyalty benefits (e.g. incentives). The transaction data may be collected by card issuer systems 80 for example, such as when customer uses an acquired account (e.g. credit card, debit card) for payment. The transaction data may be provided to loyalty system 20 via transaction data 58 at data storage device 58.

Loyalty system 20 is operable to store the data items mentioned above (and other similar data items) to the data storage device 50 and apply same against transactions between participating members and participating merchants. Loyalty system 20 may use the data items to recommend incentives or affinity entities, and corresponding transactions.

A Point conversion utility (not shown) enables enhancement of loyalty programs based upon points or donations as VPC holder benefits created by VPC holder use in connection with a loyalty program and provided by incentives offered to VPC holders. The point conversion utility may allow the merchant to reward their VPC holders in form of donations by converting loyalty program points to donation amounts. These points, donations, and rewards are examples of incentives. For example, point conversion utility may calculate 100 points for a transaction and record the transaction information and related conversion amount 100 points as VPC holder attributes in storage device 50. The point conversion utility may also convert points from loyalty programs for specific card issuers to points for corresponding loyalty programs managed by loyalty system.

An example process in connection with the generation of reports based on the contents of data storage device 50 will now be described. A system administrator of the operator of the loyalty system 20 may access certain reports in connection with merchant activity in connection with customer demographics. Similar processes and system implementations may be used to generate other reports of information accessible to merchants, or members. The loyalty system 20 is operable to generate reports for merchants to track the use and monitor the results.

Loyalty system 20 may enable a merchant to target incentives to particular sub-groups of VPC holders, depending on their interest (e.g. VPC holder attributes) to merchant.

After a VPC holder transaction has been completed the transaction data may be relayed to the loyalty system 20. The loyalty system 20 defines in accordance with a particular loyalty program a set of rules to complement loyalty programs by processing the transaction data (e.g. identified merchant, amount of transaction, date of transaction, time of transaction) to convert the transaction into points in connection with parameters set by each participating merchant. For instance, the system 20 may convert transaction incentives or prizes within the loyalty program to points to the VPC holder based on a pre-determined formula. The loyalty system 20 would for example convert a $100.00 spent by a VPC holder under a loyalty program into 100 points if the transaction was completed between the hours of 00:00:00 and 12:00:00 Monday through Friday and 50 points at any other time for the particular card used at a particular merchant.

As previously stated, a merchant belonging to the loyalty system 20 may choose to offer rewards/incentives/offers based upon time of day and date. The incentives may also be based on a particular good or service. The merchant provides selected information relating to particular demographics, affinity entities, transactions, dates and times (e.g. attributes). The loyalty system identifies the merchant, the time of day and the date and applies differential incentives through the loyalty system. The incentives may relate to a donation to an affinity entity as managed by donation utility 26.

Benefits, offers, or incentives may be accrued on behalf of members (including members who are VPC holders) in a number of ways. The benefits themselves can vary. For example, pre-set benefit application or payment rates are associated with particular transactions associated with the loyalty system 20.

Within the loyalty system 20, merchants may be motivated to develop new and innovative loyalty programs (through the use of recommended incentives) that will automatically be accessible to VPC holders. Loyalty system 20 may provide a means of generating financial transactions and/or customers for merchants.

Loyalty system 20 may provide flexibility in the arrangements made by the merchants, as it relates to the benefits provided to VPC holders who become members. These arrangements can define the pre-determined benefits associated with particular transactions, e.g. a per transaction benefit to the VPC holder.

Other configurations and extensions may be implemented by loyalty system 20. For example, various security methods and technologies for restricting access to resources of the loyalty system 20 to those authorized to do so by the operator of the loyalty system 20 may be used. Loyalty system 20 may use various existing and future technologies to process payments by operation of the transaction utility. Loyalty system 20 may provide various tools and interfaces for interacting with the loyalty system. The system 20 may also allow for robust reporting which may include comparative reports of member affinity or of transaction history with participating merchants. In other words, member transaction history may be different for differing groups of members based on member affinity.

Data storage device 50 maintains benefits accounts 52, merchant accounts 54, member accounts 56, transaction data 58 for storing attributes regarding offers/incentives, merchants, VPC holders and transactions. Data storage device 50 may provide a persistent store for the various databases described herein. The attributes may be used to determine incentives in relation to various loyalty programs, and affinity entities to provide donations to. For example, data scrub utility 36 may retrieve data from data storage device 50 for provision to recommendation engine 30 to recommend offers involving donations to affinity entities, offers for merchants proximate to a location related to the customer (current location of customer device 48, location of customer's workplace, location of customer's home, and so on). Data scrub utility 36 may normalize, scrub, convert and perform other operations on data received from other systems (e.g. merchant system 40, affinity system 60, VPC issuer system 88).

VPC holder registration 24 may enable VPC holders to register for loyalty programs. VPC holder registration 24 may populate VPC holder and transaction data 56, 58 based on data collected from registration. The Merchant reporting tool 46 may generate reports based on VPC holder and transaction data 58 and data maintained by loyalty system 20 as part of data storage device 50. Data storage device 50 may maintain a copy of VPC holder and transaction data 58, or may contain separate data. Loyalty program module 22 may be used to create and manage various loyalty programs for merchant system 40.

Loyalty system 20 may include a merchant interface 28 for interacting with merchant system 40 and generating various interfaces for display on merchant system 40. The merchant interface 28 may provide a mechanism for merchant system 40 to create, customize, and manage loyalty programs and incentives. Data scrub utility 36 may normalize, scrub, convert and perform other operations on data received from merchant system 40. Data scrub utility 36 may normalize, scrub, convert and perform other operations on data received from VPC issuer system 88.

Merchant system 40 may be configured with various computing applications, such as merchant reporting tool 46 for generating reports regarding loyalty programs and for displaying interfaces received from merchant interface 28 to create, customize, and manage loyalty programs and incentives, and view donation results for affinity entities, and so on. A computing application may correspond to hardware and software modules comprising computer executable instructions to configure physical hardware to perform various functions and discernible results. A computing application may be a computer software or hardware application designed to help the user to perform specific functions, and may include an application plug-in, a widget, instant messaging application, mobile device application, e-mail application, online telephony application, java application, web page, or web object residing, executing, running or rendered on the merchant system 40. Merchant system 40 is operable to authenticate merchants (using a login, unique identifier, and password for example) prior to providing access to applications and loyalty system 40. Merchant system 40 may be different types of devices and may serve one user or multiple merchants. Although merchant system 40 is depicted with various components in FIG. 1 as a non-limiting illustrative example, merchant system 40 may contain additional or different components, such as point of sale system or other transaction processing system.

Merchant system 40 may include one or more input devices, such as a keyboard, mouse, camera, touch screen and a microphone, and may also include one or more output devices such as a display screen and a speaker. Merchant system 40 has a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one merchant system 40 is shown for clarity, there may be multiple merchant systems 40 or groups of merchant systems 40 distributed over a wide geographic area and connected via e.g. network.

Merchant system 40 includes data storage devices storing merchant data 42 particular to the merchant, such as geographic location, inventory records, historical records, and the like. Data storage devices may also store customer and transaction data 44 such as customer names, addresses, contact information, target potential customers, transaction details, and so on.

Merchant system 40 may also include a kiosk or customer interface device to receive data from customers and determine location of customers (e.g. a customer is present in-store). This data may be used as the location identifier for the customer. This data may also be used to trigger the incentive and donation, as the kiosk or customer interface device provides a mechanism to verify that the customer is present at the brick and mortar store. Merchant system 40 may also include near field communication (NFC) technology to detect that customer device 48 is present in a brick and mortar store of merchant to trigger donations and incentives.

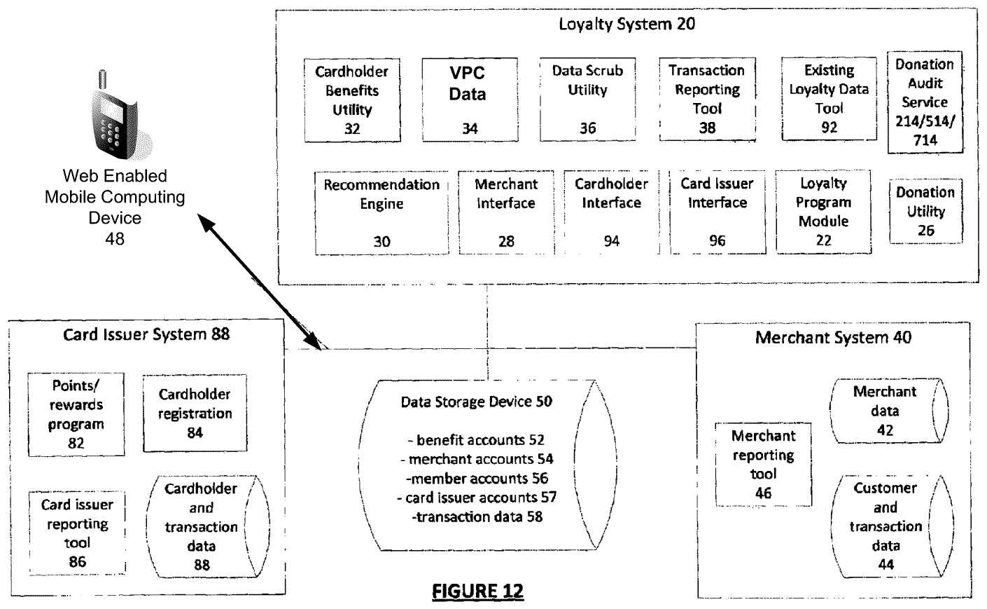

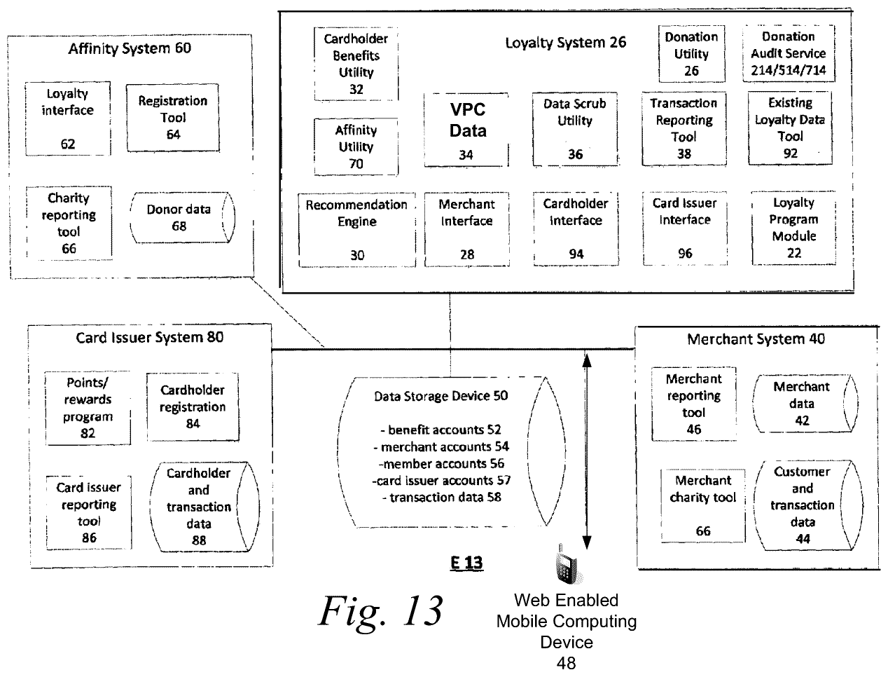

VPC issuer system 80/88 may be configured with various computing applications, such as card issuer reporting tool 86 for generating reports regarding loyalty programs and for displaying interfaces received from loyalty system 20 to create, customize, and manage loyalty programs and incentives, and view donation results for affinity entities, and so on. A computing application may correspond to hardware and software modules comprising computer executable instructions to configure physical hardware to perform various functions and discernible results. A computing application may be a computer software or hardware application designed to help the user to perform specific functions, and may include an application plug-in, a widget, instant messaging application, mobile device application, e-mail application, online telephony application, java application, web page, or web object residing, executing, running or rendered on the merchant system 40. VPC issuer system 80/88 is operable to authenticate users (using a login, unique identifier, and password for example) prior to providing access to applications and loyalty system 20. VPC issuer system 80/88 may be different types of devices and may serve one user or multiple VPC issuers. Although VPC issuer system 80/88 is depicted with various components in FIGS. 12-13 as a non-limiting illustrative example, VPC issuer system 80/88 may contain additional or different components, such as point of sale system or other transaction processing system.

VPC issuer system 80/88 may include one or more input devices, such as a keyboard, mouse, camera, touch screen and a microphone, and may also include one or more output devices such as a display screen and a speaker. VPC issuer system 80/88 has a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one VPC issuer system 80/88 is shown for clarity, there may be multiple card issuer systems 80 or groups of card issuer systems 80 distributed over a wide geographic area and connected via e.g. network.

VPC issuer system 80/88 includes data storage devices storing merchant data 42 particular to the merchant, such as geographic location, inventory records, historical records, and the like. Data storage devices may also store customer and transaction data 44 such as customer names, addresses, contact information, target potential customers, transaction details, and so on.

Customer device 48, which is preferably a web access device, may include processor and data storage devices. Customer device 48 may include one or more input devices, such as a keyboard, mouse, camera, touch screen and a microphone, and may also include one or more output devices such as a display screen and a speaker. Customer device 48 has a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one customer device 48 is shown for clarity, there may be multiple merchant systems 40 or groups of customer device 48 distributed over a wide geographic area and connected via e.g. network. Customer device 48 is configured with GPS, NFC or other location detection hardware to determine location of customer (e.g. location identifier) and to verify if the customer is present in a brick and mortar store of merchant.

Customer device 48 may be implemented using a mobile phone, mobile computing device, tablet, laptop, desktop, wearable device, IVI device, navigation system and so on. FIGS. 10 to 13 illustrate an example customer device 48 integrated with or located within a vehicle. This may illustrate a customer who is driving the vehicle, for example. The customer device 48 may also be carried by a customer who is not associated with a vehicle.

Where disclosed implementations are directed to an IVI (In-Vehicle Infotainment) device, such as may be installed as original factory equipment in a new automobile (e.g. the customer device 48 shown in an automobile in FIG. 10), the application executing to perform the disclosed implementations, and its IVI device, will preferably have multifunctional communications to connect the automobile to the cloud for different functions. As such, implementations disclosed here will interoperate with the automobile's built-in mapping and navigational system and thereby gain the advantage of understanding the driver's mission to verbally request and receive relevant and timely alerts about local business that want to help charities that serve the driver's community when the driver does business with those local businesses, and to navigate to those local business to take advantage of any such timely alert. The navigational system may communicate a current location of the customer and provide directions to the location of the merchant associated with the selected offer, for example.

Of course, implementations directed to an IVI device may also interoperate with other functionalities, such as telematics (e.g., Onstar), navigation, the logging of diagnostics, connecting to internet radio (e.g., Pandora), and connecting telephone calls. As such, disclosed implementations with an IVI device (e.g. customer device 48) or otherwise with connected automobile passengers' smartphones and/or e-tablets with IVI features and other cloud and Internet services. Any such IVI system implementation will preferably prioritize alerts to avoid distracting the driver, and most preferably will deliver such information to the driver, as disclosed elsewhere herein, as audio rendered alerts to avoid being a related cause to an accident or an injury, and also to avoid potential consequences of driver distraction from the user interface to the IVI system.

Loyalty system 20 (and in particular donation utility 26) may interact with an affinity system 60 to provide charitable incentives (e.g. an incentive involving a donation by the merchant to an affinity entity). Affinity system 60 may include a data storage device with donor data 68. Affinity system 60 may include a loyalty interface 62 for generating interfaces populated with data from loyalty system 20.

For example, a correlation may be made between donor data 68 and benefits accounts 52 or VPC holder data 58 to determine whether any donors are also VPC holders. If so, then recommendation engine 30 may recommend an incentive with a donation portion to the affinity entity associated with affinity system 60.

Affinity system 60 may include a registration tool 64 to register users to become donors, and potentially VPC holders of a loyalty program created by loyalty system 20. The registration tool 64 provides a mechanism to collect attributes regarding donors.

Affinity system 60 or affinity utility 70 is operable to identifying donors associated with an affinity entity. The donors may be VPC holders or potential VPC holders for a loyalty program provided by loyalty system 20. The donors are associated with attributes, such as the example attributes described herein in relation to VPC holders.

Affinity system 60 or affinity utility 26 is operable to determine which donors are VPC holders and which are not. Affinity system 60 or affinity utility 26 is operable to invite those donors which are not VPC holders to participate in a loyalty program offering incentives that include donations to the affinity entity. These may be recommended incentives based on their past donations.

Affinity system 60 or affinity utility 26 is operable to identify a merchant and a transaction. Affinity system 60 may contact a merchant upon detecting that a subset of donors are also customers, potential customers, or VPC holders to arrange for an incentive provided by merchant that includes a donation to the affinity entity. The transaction may identify a good or service of interest to the donors based on the attributes.

Affinity system 60 or affinity utility 70 is operable to select an incentive based on the affinity entity, the attributes, the merchant, and the transaction. The incentive defines a benefit provided by the merchant to the affinity entity upon the occurrence of a transaction involving the merchant and one or more donors. In this way, a donor is motivated to transact with the merchant due to the donation provided to their preferred affinity entity. Affinity system 60 or affinity utility 70 may contact donors encouraging them to transact with a merchant, as this may result in an increase in donations to the affinity entity. The merchant may have access to a new set of potential customers via affinity system 60. The loyalty system 20 may consider the buying patterns of donors to recommend incentives with a donation component. This also allows merchants to see what customers who are also donors and tailor incentives accordingly.

Affinity system 60 may be used to manage events and the attendee list may also receive the recommended incentive. This may increase transactions for merchants, as well as increase donations if there is an additional incentive offered by merchants. The merchant and charity may set a donation rate which may be a fixed or proportional amount. For example, a percentage of the transaction amount may be given as a donation.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor. Data storage device 50 may provide a persistent store for databases described herein.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to tangible actions or processes of a specific apparatus, such as a special purpose computer or a similar special purpose electronic computing device that generate discernible results. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, various other modifications may be made, and equivalents may be substituted, without departing from claimed subject matter. Additionally, many modifications may be made to adapt a particular situation to the teachings of claimed subject matter without departing from the central concept described herein. Therefore, embodiments may not be limited to the particular examples disclosed, but may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the method and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of embodiments described herein. However, some embodiments may be practiced without these specific details. In other instances, methods and systems that would be known by one of ordinary skill have not been described in detail so as not to obscure claimed subject matter.

What is claimed is:

1. A method comprising:
sending a communication bearing a payload representative of an inactive Virtual Payment Card (VPC) to each of a plurality of logical addresses respectively corresponding to a web access device of a user, wherein each said inactive VPC:
is issued by an issuer bank to one said user of one said web access device;
is loaded with funding provided to the issuer bank by a sponsor; and
is represented by a globally unique identifier (GUID);
receiving, from each said web access device, activation data;
activating, using the received activation data, the corresponding said loaded inactive VPC;
and
for each said loaded active VPC initiating an online transaction with a merchant using the loaded active VPC, funding, by the merchant, a merchant-defined donation for receipt by a charity.

2. The method as defined in claim 1, wherein, prior to the funding by the merchant of the merchant-defined donation for receipt by the charity, the method further comprises:
sending, for the loaded active VPC initiating the online transaction with the merchant using the loaded active VPC, an authorization request from an acquirer bank for the merchant for delivery to the issuer bank; and
receiving an authorization response to the authorization request indicating that the online transaction has been authorized by the issuer bank.

3. The method as defined in claim 2, wherein a result contained in the authorization response is derived from comparisons of:
a currency amount of the transaction amount to the stored value on the loaded activated VPC; and
an identifier for the merchant that is contained on a merchant white list.

4. The method as defined in claim 1, wherein the plurality of inactive VPCs are loaded by the sponsor provided funding in varied stored value amounts.

5. The method as defined in claim 1, further comprising, for each said user of a web access device conducting one said online transaction with the merchant using the loaded active VPC, generating and communicating a post-transaction survey to the logical address corresponding of the web access device.

6. The method as defined in claim 1, wherein transaction data from the online transaction with the merchant using the loaded active VPC is communicated, at least in part, using a short range wireless network operating protocol that is at least one of the 802.11 family of standards and the frequency range of 2.4 to 2.48 GHz.

7. The method as defined in claim 1, wherein the merchant-defined donation for receipt by the charity is generated using a neural network of an artificial intelligence engine.

8. The method as defined in claim 7, wherein:
the transaction data from the online transaction with the merchant using the loaded active VPC is conducted by one said user of one said web access device; and
the generating of the one or more incentives using the neural network of the artificial intelligence engine uses:
a corresponding member profile of the one said user of one said web access device; and
a corresponding merchant profile of the merchant.

9. The method as defined in claim 1, wherein:
the transaction associated with the merchant of the one or more merchants is conducted by said user of a web access device; and
transaction data for the transaction between the user of the web access device and the merchant is communicated by data signals exchanged via near field communication (NFC) devices for the online transaction between user of a web access device and the merchant.

10. A non-transient computer-readable medium on which are encoded instructions for carrying out the method of claim 1.

11. A system comprising:
at least one processor;
a network interface;
memory storing instructions executable at the at least one processor to cause the system to:
send a communication bearing a payload representative of an inactive Virtual Payment Card (VPC) to each of a plurality of logical addresses respectively corresponding to a web access device of a user, wherein each said inactive VPC:
is issued by an issuer bank to one said user of one said web access device;
is loaded with funding provided to the issuer bank by a sponsor; and
is represented by a globally unique identifier (GUID);
receive, from each said web access device, activation data;
activate, using the received activation data, the corresponding said loaded inactive VPC;
and
for each said loaded active VPC initiating an online transaction with a merchant using the loaded active VPC, fund, by the merchant, a merchant-defined donation for receipt by a charity.

12. The system as defined in claim 11, wherein, prior to the funding by the merchant of the merchant-defined donation for receipt by the charity, the memory storing instructions executable at the at least one processor further causes the system to:
send, for the loaded active VPC initiating the online transaction with the merchant using the loaded active VPC, an authorization request from an acquirer bank for the merchant for delivery to the issuer bank; and
receive an authorization response to the authorization request indicating that the online transaction has been authorized by the issuer bank.

13. The system as defined in claim 12, wherein a result contained in the authorization response is derived from comparisons of:
a currency amount of the transaction amount to the stored value on the loaded activated VPC; and
an identifier for the merchant that is contained on a merchant white list.

14. The system as defined in claim 11, wherein the plurality of inactive VPCs are loaded by the sponsor provided funding in varied stored value amounts.

15. The system as defined in claim 11, wherein the memory storing instructions executable at the at least one processor further causes the system, for each said user of a web access device conducting one said online transaction with the merchant using the loaded active VPC, to generate and communicate a post-transaction survey to the logical address corresponding of the web access device.

16. The system as defined in claim 11, wherein transaction data from the online transaction with the merchant using the loaded active VPC is communicated, at least in part, using a short range wireless network operating protocol that is at least one of the 802.11 family of standards and the frequency range of 2.4 to 2.48 GHz.

17. The system as defined in claim 11, wherein the merchant-defined donation for receipt by the charity is generated using a neural network of an artificial intelligence engine.

18. The system as defined in claim 7, wherein:
the transaction data from the online transaction with the merchant using the loaded active VPC is conducted by one said user of one said web access device; and
the generating of the one or more incentives using the neural network of the artificial intelligence engine uses:
a corresponding member profile of the one said user of one said web access device; and
a corresponding merchant profile of the merchant.

19. The method as defined in claim 1, wherein:
the transaction associated with the merchant of the one or more merchants is conducted by said user of a web access device; and
transaction data for the transaction between the user of the web access device and the merchant is communicated by data signals exchanged via near field communication (NFC) devices for the online transaction between user of a web access device and the merchant.

20. A non-transitory computer-readable medium or media storing computer instructions which when executed by a redemption server in communication with an issuer bank causes the redemption server to perform a method comprising:
receiving funding from a sponsor for varied stored value amounts to be load to a plurality of inactive Virtual Payment Cards (VPCs);
sending a communication bearing a payload representative of an inactive Virtual Payment Card (VPC) to each of a plurality of logical addresses respectively corresponding to a web access device of a user, wherein each said inactive VPC:
is issued by the issuer bank to one said user of one said web access device;
is loaded with funding provided to the issuer bank by a sponsor; and
is represented by a globally unique identifier (GUID);
receiving, from each said web access device, activation data;
activating, using the received activation data, the corresponding said loaded inactive VPC;
and
for each said loaded active VPC initiating an online transaction with a merchant using the loaded active VPC:
sending, for the loaded active VPC initiating the online transaction with the merchant using the loaded active VPC, an authorization request from an acquirer bank for the merchant for delivery to the issuer bank;
receiving an authorization response to the authorization request indicating that the online transaction has been authorized by the issuer bank, wherein a result contained in the authorization response is derived from comparisons of:
a currency amount of the transaction amount to the stored value on the loaded activated VPC; and
an identifier for the merchant that is contained on a merchant white list; and
funding, by the merchant, a merchant-defined donation for receipt by a charity.
